(19) United States
(12) Patent Application Publication
(10) Pub. No.: US 2025/0383716 A1
(43) Pub. Date: Dec. 18, 2025

(54) INFORMATION PROCESSING APPARATUS, INFORMATION PROCESSING METHOD, AND INFORMATION PROCESSING SYSTEM

(71) Applicant: SONY GROUP CORPORATION, TOKYO (JP)

(72) Inventors: TAKUMI TSURU, TOKYO (JP); TOSHIYA HAMADA, TOKYO (JP); RYOHEI TAKAHASHI, TOKYO (JP)

(21) Appl. No.: 18/878,116

(22) PCT Filed: May 31, 2023
(86) PCT No.: PCT/JP2023/020209

§ 371 Date: Dec. 23, 2024

(30) Foreign Application Priority Data
Jul. 4, 2022 (JP) 2022-107583

(51) Int. Cl. G06F 3/01; G06F 3/16

(52) U.S. Cl. CPC G06F 3/017; G06F 3/013; G06F 3/167

(57) ABSTRACT

A present information processing apparatus includes a starting predictive behavior determination unit, an ending predictive behavior determination unit, and a resource setting unit. The starting predictive behavior determination unit determines, with respect to another user object that is a virtual object corresponding to another user within a three-dimensional space, presence or absence of a starting predictive behavior that becomes a sign to start an interaction with a user. The ending predictive behavior determination unit determines, with respect to an interaction target object that is the another user object that has been determined as having taken the starting predictive behavior, presence or absence of an ending predictive behavior that becomes a sign to end the interaction. The resource setting unit sets, with respect to the interaction target object, processing resources that are used in processing for improving reality to be relatively high until it is determined that the ending predictive behavior has been taken.

### TECHNICAL FIELD

The present technology relates to an information processing apparatus, an information processing method, and an information processing system that are applicable to broadcasting of VR (Virtual Reality) videos and the like.

### BACKGROUND ART

In recent years, 360-degree videos that have been taken by a 360-degree camera and the like and can capture views in all directions are starting to be broadcasted as VR videos. In addition, recently, development of a technology of broadcasting 6DoF (Degree of Freedom) videos (also referred to as 6DoF content) with which viewers (users) can look all around (freely select a direction of a line of sight) and freely move within a three-dimensional space (can freely select a viewpoint position) is in progress.

Patent Literature 1 discloses a technology that is capable of improving robustness of content reproduction regarding the broadcasting of 6DoF content.

Non-Patent Literature 1 describes that in interpersonal communication, an approach behavior or a behavior of turning a body toward a partner (directing eyes toward the partner) is taken before communication starts explicitly.

Non-Patent Literature 2 describes that in interpersonal communication, conversations are not constantly held with the partner and one is also not constantly looking at the partner. The present literature defines such communication as “communication based on presence” and claims that the presence can be used to maintain a relationship (communication) with a target having the presence. It is also claimed that this presence is an ability of the target to draw attention toward oneself and that auditory information is most important outside eyesight.

### CITATION LIST

### Patent Literature

Patent Literature 1: WO 2020/116154

### Non-Patent Literature

Non-Patent Literature 1: “Investigation of two-dimensional model of interpersonal action intensity by simulation of approach behavior in encounters” by Takafumi Sakamoto, Akihito Sudo, and Yugo Takeuchi, HAI (Human-Agent Interaction) Symposium 2017

Non-Patent Literature 2: “Interaction by Agent Existence-Creating Existence by Sound-” by Yusaku Itagaki, Kohei Ogawa, and Tetsuo Ono, HAI Symposium 2006

### DISCLOSURE OF INVENTION

### Technical Problem

It is considered that the broadcasting of virtual videos (virtual video) such as a VR video will prevail, and thus a technology with which a high-quality bidirectional virtual space experience exemplified by remote communication or a remote work can be realized will be demanded from now on.

In view of the circumstances as described above, the present technology aims at providing an information processing apparatus, an information processing method, and an information processing system that are capable of realizing the high-quality bidirectional virtual space experience.

### Solution to Problem

To attain the object described above, an information processing apparatus according to an embodiment of the present technology includes a starting predictive behavior determination unit, an ending predictive behavior determination unit, and a resource setting unit.

The starting predictive behavior determination unit determines, with respect to another user object that is a virtual object corresponding to another user within a three-dimensional space, presence or absence of a starting predictive behavior that becomes a sign to start an interaction with a user.

The ending predictive behavior determination unit determines, with respect to an interaction target object that is the another user object that has been determined as having taken the starting predictive behavior, presence or absence of an ending predictive behavior that becomes a sign to end the interaction.

The resource setting unit sets, with respect to the interaction target object, processing resources that are used in processing for improving reality to be relatively high until it is determined that the ending predictive behavior has been taken.

In this information processing apparatus, the presence or absence of the starting predictive behavior and the presence or absence of the ending predictive behavior are determined with respect to the another user object within the three-dimensional space. Then, the processing resources that are used in the processing for improving reality is set to be relatively high until the interaction target object that has been determined as having taken the starting predictive behavior is determined to have taken the ending predictive behavior. As a result, a high-quality bidirectional virtual space experience can be realized.

The starting predictive behavior may include a behavior that becomes a sign to start an interaction between a user object that is a virtual object corresponding to the user and the another user object. In this case, the ending predictive behavior may include a behavior that becomes a sign to end the interaction between the user object and the another user object.

The starting predictive behavior may include at least one of the user object performing an interaction-related behavior related to the interaction with resect to the another user object, the another user object performing the interaction-related behavior with respect to the user object, the another user object responding to, by the interaction-related behavior, the interaction-related behavior that has been performed by the user object with respect to the another user object, the user object responding to, by the interaction-related behavior, the interaction-related behavior that has been performed by the another user object with respect to the user object, or the user object and the another user object mutually performing the interaction-related behavior.

The interaction-related behavior may include at least one of speaking while looking at a partner, performing a predetermined gesture while looking at the partner, touching the partner, or touching a same virtual object that the partner is touching.

The ending predictive behavior may include at least one of moving away while being mutually out of eyesight of a partner, an elapse of a certain time while being mutually out of the eyesight of the partner and taking no action with respect to the partner, or an elapse of a certain time while being mutually out of a central visual field of the partner and taking no visual action with respect to the partner.

The starting predictive behavior determination unit may determine the presence or absence of the starting predictive behavior on the basis of user information related to the user and another user information related to the another user. In this case, the ending predictive behavior determination unit may determine the presence or absence of the ending predictive behavior on the basis of the user information and the another user information.

The user information may include at least one of eyesight information of the user, motion information of the user, voice information of the user, or contact information of the user. In this case, the another user information may include at least one of eyesight information of the another user, motion information of the another user, voice information of the another user, or contact information of the another user.

The processing resources that are used in the processing for improving reality may include processing resources used in at least one of high-quality picture processing for improving visual reality or low-latency processing for improving responsive reality in the interaction.

The information processing apparatus may further include a friendship level calculation unit which calculates a friendship level of the another user object with respect to the user object. In this case, the resource setting unit may set the processing resources with respect to the another user object on the basis of the calculated friendship level.

The friendship level calculation unit may calculate the friendship level on the basis of at least one of a number of times the interaction has been made up to a current time point or an accumulated time of the interaction up to the current time point.

The information processing apparatus may further include a priority processing determination unit which determines processing to which the processing resources are to be preferentially allocated with respect to a scene constituted of the three-dimensional space. In this case, the resource setting unit may set the processing resources with respect to the another user object on the basis of a result of the determination by the priority processing determination unit.

The priority processing determination unit may select either one of high-quality picture processing or low-latency processing as the processing to which the processing resources are to be preferentially allocated.

The priority processing determination unit may determine the processing to which the processing resources are to be preferentially allocated on the basis of three-dimensional space description data that defines a configuration of the three-dimensional space.

An information processing method according to an embodiment of the present technology is an information processing method executed by a computer system and includes determining, with respect to another user object that is a virtual object corresponding to another user within a three-dimensional space, presence or absence of a starting predictive behavior that becomes a sign to start an interaction with a user.

With respect to an interaction target object that is the another user object that has been determined as having taken the starting predictive behavior, presence or absence of an ending predictive behavior that becomes a sign to end the interaction is determined.

With respect to the interaction target object, processing resources that are used in processing for improving reality are set to be relatively high until it is determined that the ending predictive behavior has been taken.

An information processing system according to an embodiment of the present technology includes the starting predictive behavior determination unit, the ending predictive behavior determination unit, and the resource setting unit.

### BRIEF DESCRIPTION OF DRAWINGS

FIG. 1 A schematic diagram showing a basic configuration example of a remote communication system.

FIG. 2 A schematic diagram for explaining rendering processing.

FIG. 3 A schematic diagram for explaining a method of performing resource distribution according to only a distance from a user.

FIG. 4 Schematic diagrams showing an example of a case where the processing resource distribution is simulated by a method of allocating many resources to a partner of an action to perform next.

FIG. 5 A schematic diagram showing a basic configuration for realizing a processing resource setting according to the present technology.

FIG. 6 A flowchart showing basic operations in the processing resource setting according to the present technology.

FIG. 7 A schematic diagram showing a configuration example of a client apparatus according to a first embodiment.

FIG. 8 A flowchart showing an example of starting predictive behavior determination according to the present embodiment.

FIG. 9 A flowchart showing an example of ending predictive behavior determination according to the present embodiment.

FIG. 10 Schematic diagrams for explaining specific application examples of the processing resource distribution according to the present embodiment.

FIG. 11 A schematic diagram for explaining an embodiment in which determination of an interaction target that uses the starting predictive behavior determination and the ending predictive behavior determination according to the present embodiment and the processing resource distribution that uses the distance from the user and a viewing direction are combined.

FIG. 12 A schematic diagram showing a configuration example of a client apparatus according to a second embodiment.

FIG. 13 A flowchart showing an update example of a user acquaintance list linked to the starting predictive behavior determination.

FIG. 14 A flowchart showing an update example of the user acquaintance list linked to the ending predictive behavior determination.

FIG. 15 A schematic diagram for explaining an example of the processing resource distribution that uses a closeness level.

FIG. 16 A schematic diagram showing an example of the processing resource distribution in a case where the closeness level is not used.

FIG. 17 A schematic diagram showing a configuration example of a client apparatus according to a third embodiment.

FIG. 18 A flowchart showing an example of processing of acquiring a scene description file that is used as scene description information.

FIG. 19 A schematic diagram showing an example of information described in the scene description file.

FIG. 20 A schematic diagram showing an example of information described in the scene description file.

FIG. 21 A schematic diagram showing an example of information described in the scene description file.

FIG. 22 A schematic diagram showing an example of information described in the scene description file.

FIG. 23 A schematic diagram for explaining a configuration example of a server-side rendering system.

FIG. 24 A block diagram showing a hardware configuration example of a computer (information processing apparatus) capable of realizing a broadcasting server, a client apparatus, and a rendering server.

### MODES FOR CARRYING OUT THE INVENTION

Hereinafter, embodiments according to the present technology will be described while referring to the drawings.

### [Remote Communication System]

Regarding a remote communication system according to an embodiment of the present technology, a basic configuration example and a basic operation example will be described.

The remote communication system is a system in which a plurality of users can perform communication while sharing a virtual three-dimensional space (three-dimensional virtual space). The remote communication can also be called Volumetric remote communication.

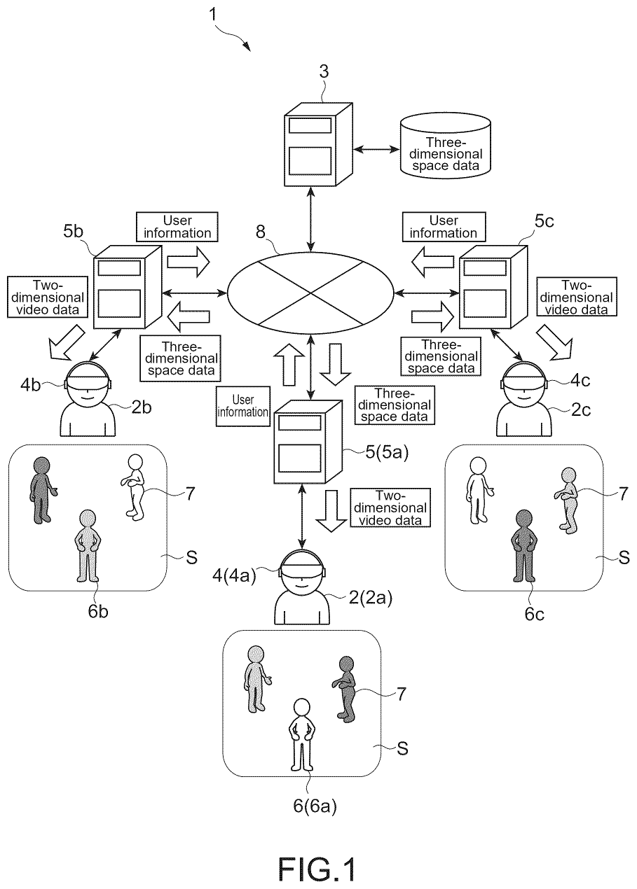

FIG. 1 is a schematic diagram showing a basic configuration example of the remote communication system.

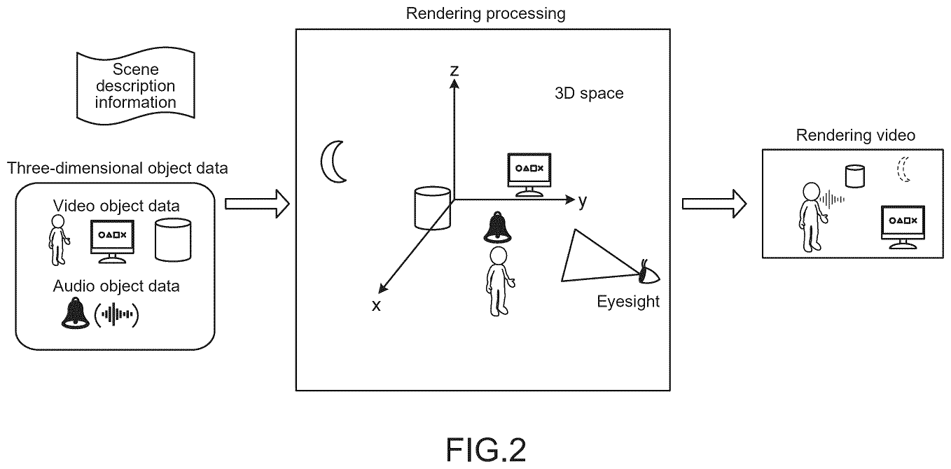

FIG. 2 is a schematic diagram for explaining rendering processing.

In FIG. 1, three users 2 including users 2a to 2c are illustrated as the users 2 who use the remote communication system 1. Of course, the number of users 2 who are capable of using the remote communication system 1 is not limited, and a larger number of users 2 can mutually perform communication via a three-dimensional virtual space S.

The remote communication system 1 shown in FIG. 1 corresponds to an embodiment of an information processing system according to the present technology. Further, the virtual space S shown in FIG. 1 corresponds to an embodiment of a virtual three-dimensional space according to the present technology.

In the example shown in FIG. 1, the remote communication system 1 includes a broadcasting server 3 and HMDs (Head Mounted Displays) 4 (4a to 4c) and client apparatuses 5 (5a to 5c) prepared for the respective users 2.

The broadcasting server 3 and each of the client apparatuses 5 are communicably connected via a network 8. The network 8 is constructed by, for example, the Internet, a wide area communication network, or the like. Alternatively, an arbitrary WAN (Wide Area Network), LAN (Local Area Network), or the like may be used, and a protocol for constructing the network 8 is not limited.

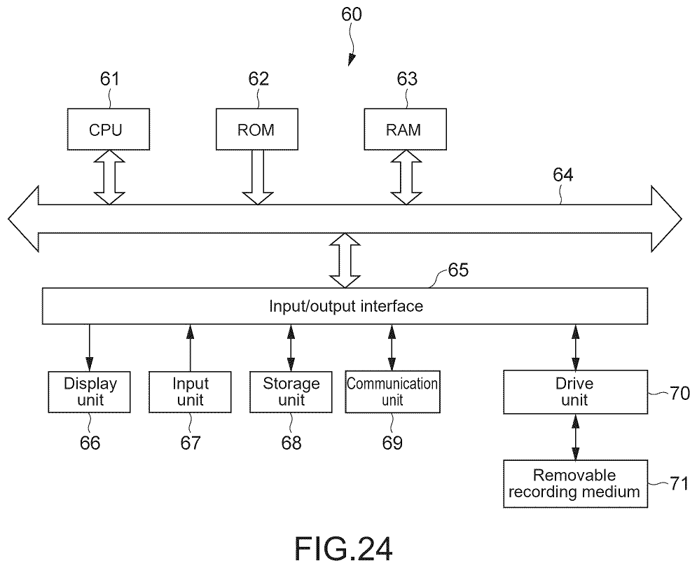

The broadcasting server 3 and the client apparatuses 5 each include hardware requisite for a computer, the hardware including, for example, for example, a processor such as a CPU, a GPU, and a DSP, a memory such as a ROM and a RAM, a storage device such as an HDD, and the like (see FIG. 24). The processor loads a program according to the present technology that is stored in a storage unit or the memory in the RAM and executes the program, to thus execute an information processing method according to the present technology.

For example, the broadcasting server 3 and the client apparatuses 5 can each be realized by an arbitrary computer such as a PC (Personal Computer). Of course, hardware such as an FPGA and an ASIC may also be used.

The HMD 4 and the client apparatus 5 that are prepared for each of the users 2 are communicably connected to each another. A communication form for communicably connecting both devices is not limited, and an arbitrary communication technology may be used. For example, wireless network communication such as Wi-Fi, near field communication such as Bluetooth (registered trademark), or the like can be used. It is noted that the HMD 4 and the client apparatus 5 may be structured integrally. In other words, functions of the client apparatus 5 may be mounted on the HMD 4.

The broadcasting server 3 broadcasts three-dimensional space data to each of the client apparatuses 5. The three-dimensional space data is used in rendering processing that is executed for expressing the virtual space S (three-dimensional space). By executing the rendering processing on the three-dimensional space data, a virtual video to be displayed by the HMD 4 is generated. In addition, virtual voice is output from headphones of the HMD 4. The three-dimensional space data will be described later in detail.

The HMD 4 is a device used for displaying, to the user 2, a virtual video of each scene that is constituted of the virtual space S and also outputting virtual voice. The HMD 4 is worn on a head of the user 2 to be used. For example, in a case where a VR video is broadcasted as the virtual video, an immersive HMD 4 that is configured to cover the eyesight of the user 2 is used. In a case where an AR (Augmented Reality) video is broadcasted as the virtual video, AR glasses or the like are used as the HMD 4.

Devices other than the HMD 4 may alternatively be used as the device for providing virtual videos to the user 2. For example, the virtual video may be displayed by a display provided in a television, a smartphone, a tablet terminal, a PC, and the like. Moreover, the device capable of outputting virtual voice is also not limited, and a speaker or the like of any form may be used.

In the present embodiment, a 6DoF video is provided as the VR video to the user 2 wearing the immersive HMD 4. In the virtual space S, the user 2 can view a video in an all-round 360° range in front-back, left-right, and up-down directions.

For example, in the virtual space S, the user 2 freely moves the viewpoint position, the direction of the line of sight, and the like to freely change eyesight of oneself (eyesight range). The virtual video to be displayed to the user 2 is switched according to this change of eyesight of the user 2. By performing an operation of turning the head, tilting the head, or looking back, the user 2 can look around in the virtual space S in a sense that is the same as that in the real world.

In this manner, in the remote communication system 1 according to the present embodiment, it becomes possible to broadcast a photorealistic free viewpoint video and provide a viewing experience at free viewpoint positions.

As shown in FIG. 1, in the present embodiment, in each scene constituted of the virtual space S, an avatar 6 (6A to 6C) of oneself is displayed at a center of the eyesight of each user 2. In the present embodiment, motions (gestures and the like) and utterances of the user 2 are reflected on the avatar (hereinafter, will be referred to as user object) 6 of oneself. For example, when the user 2 dances, the user object 6 in the virtual space S can also perform the same dance. Further, voices uttered by the user 2 are output within the virtual space S and can be heard by other users 2.

In the virtual space S, the user objects 6 of the respective users 2 share the same virtual space S. Accordingly, avatars (hereinafter, will be referred to as other user objects) 7 of the other users 2 are also displayed on the HMD 4 of each of the users 2. It is assumed that a certain user 2 has moved to approach another user object 7 in the virtual space S. On the HMD 4 of that user 2, a state where the user object 6 of oneself approaches the another user object 7 is displayed.

On the other hand, on the HMD 4 of the another user 2, a state where the another user object 7 approaches the user object 6 of oneself is displayed. When the users 2 talk in that state, voice information corresponding to the uttered contents of the users 2 can be heard from the headphones of the HMDs 4.

In this manner, each of the users 2 can perform various interactions with the other users 2 in the virtual space S. For example, various interactions that can be performed in the real world, such as a conversation, sports, dance, and a cooperative activity of carrying an object and the like, can be performed via the virtual space S while mutually being at distant locations.

In the present embodiment, the user object 6 of oneself corresponds to an embodiment of a user object that is a virtual object corresponding to the user. In addition, the another user object 7 corresponds to an embodiment of another user object that is a virtual object corresponding to the another user.

The client apparatuses 5 respectively transmit user information related to the respective users 2 to the broadcasting server 3. In the present embodiment, the user information for reflecting the motions, utterances, and the like of the user 2 on the user object 6 in the virtual space S is transmitted from the client apparatus 5 to the broadcasting server 3. For example, eyesight information, motion information, voice information, and the like of the user are transmitted as the user information.

For example, the eyesight information of the user can be acquired by the HMD 4. The eyesight information is information related to the eyesight of the user 2. Specifically, the eyesight information includes arbitrary information with which the eyesight of the user 2 in the virtual space S can be specified.

For example, a viewpoint position, a point of gaze, a central visual field, a direction of a line of sight, a rotation angle of the line of sight, and the like can be exemplified as the eyesight information. Also as the eyesight information, a position of the head of the user 2, a rotation angle of the head of the user 2, and the like can be exemplified.

The rotation angle of the line of sight can be defined by, for example, a rotation angle that uses an axis extending in the direction of the line of sight as a rotation axis. Moreover, the rotation angle of the head of the user 2 can be defined by a roll angle, a pitch angle, and a yaw angle in a case where three axes that are set with respect to the head and are orthogonal to one another are set as a roll axis, a pitch axis, and a yaw axis.

For example, the axis extending in a front direction of the face is set as the roll axis. The axis extending in the horizontal direction when the face of the user 2 is seen from the front is set as the pitch axis, and the axis extending in the vertical direction is set as the yaw axis. The roll angle, the pitch angle, and the yaw angle with respect to these roll axis, pitch axis, and yaw axis are calculated as the rotation angle of the head. It is noted that it is also possible to use the direction of the roll axis as the direction of the line of sight.

Other arbitrary information with which the eyesight of the user 2 can be specified may also be used. One piece of information exemplified above may be used, or a combination of a plurality of pieces of information may be used as the eyesight information.

A method of acquiring the eyesight information is not limited. For example, the eyesight information can be acquired on the basis of a detection result (sensing result) acquired by a sensor apparatus (including camera) provided in the HMD 4.

For example, a camera or ranging sensor that has a periphery of the user 2 as a detection range, a front camera capable of capturing left and right eyes of the user 2, and the like are provided in the HMD 4. Furthermore, an IMU (Inertial Measurement Unit) sensor and a GPS are provided in the HMD 4. For example, positional information of the HMD 4 that is acquired by the GPS can be used as the viewpoint position of the user 2 or the position of the head of the user 2. Of course, positions of the left and right eyes of the user 2 or the like may be calculated in more detail.

Further, it is also possible to detect the direction of the line of sight from an image capturing the left and right eyes of the user 2. Furthermore, it is also possible to detect the rotation angle of the line of sight or the rotation angle of the head of the user 2 from the detection result obtained by the IMU.

Moreover, localization of the user 2 (HMD 4) may be executed on the basis of the detection result obtained by the sensor apparatus provided in the HMD 4. For example, by the localization, the positional information of the HMD 4 and attitude information that indicates which direction the HMD 4 is facing, or the like can be calculated. The eyesight information can be acquired from the positional information and the attitude information.

An algorithm for the localization of the HMD 4 is not limited, and an arbitrary algorithm such as SLAM (Simultaneous Localization and Mapping) may be used. Further, head tracking for detecting a motion of the head of the user 2 or eye tracking for detecting a motion of the line of sight of the left and right eyes of the user 2 (motion of point of gaze) may also be executed.

Alternatively, an arbitrary device or an arbitrary algorithm may be used to acquire the eyesight information. For example, in a case where a smartphone or the like is used as a device that displays a virtual video to the user 2, or the like, an image of the face (head) or the like of the user 2 may be taken, and the eyesight information may be acquired on the basis of that taken image. Alternatively, a device including a camera, an IMU, and the like may be attached to the head of the user 2 or in the periphery of the eyes of the user 2.

An arbitrary machine learning algorithm that uses, for example, DNN (Deep Neural Network) or the like may be used for generating the eyesight information. For example, generation accuracy of the eyesight information can be improved by using AI (Artificial Intelligence) that performs deep learning (deep machine learning), or the like. It is noted that the application of the machine learning algorithm may be executed with respect to arbitrary processing within the present disclosure.

The configuration, method, and the like for acquiring the motion information and voice information of the user 2 are also not limited, and an arbitrary configuration and method may be adopted. For example, a camera, a ranging sensor, a microphone, and the like may be arranged in the periphery of the user 2, and the motion information and voice information of the user 2 may be acquired on the basis of detection results thereof.

Alternatively, wearable devices of various forms such as a glove type may be worn by the user 2. A motion sensor or the like is mounted on the wearable device, and the motion information of the user and the like may be acquired on the basis of the detection result obtained from that sensor.

It is noted that the “user information” used in the present disclosure is a concept including arbitrary information related to the user and is not limited to the information that is transmitted from the client apparatus 5 to the broadcasting server 3 for reflecting the motions, utterances, and the like of the user 2 on the user object 6 in the virtual space S. For example, the broadcasting server 3 may execute analysis processing or the like on the user information transmitted from the client apparatus 5. The result of the analysis processing or the like is also included in the “user information”.

Further, for example, it is assumed that a contact with another virtual object by the user object 6 has been determined in the virtual space S on the basis of the motion information of the user. Such contact information of the user object 6 or the like is also included in the user information. In other words, information related to the user object 6 in the virtual space S is also included in the user information. For example, information indicating what kind of interaction has been made in the virtual space S may also be included in the “user information”.

Further, a case where the client apparatus 5 executes the analysis processing or the like on three-dimensional space data transmitted from the broadcasting server 3 so as to generate the “user information” is also possible. Furthermore, it is also possible to generate the “user information” on the basis of the result of the rendering processing executed by the client apparatus 5.

In other words, the “user information” is a concept including arbitrary information related to the user that is acquired in the remote communication system 1. It is noted that the “acquisition” of information and data includes both of generating information and data by predetermined processing and receiving information, data, and the like that are transmitted from other devices and the like.

It is noted that the “user information” related to another user corresponds to “another user information” related to the another user.

The client apparatus 5 executes the rendering processing on the three-dimensional space data broadcasted from the broadcasting server 3. The rendering processing is executed on the basis of the eyesight information of each of the users 2. Thus, two-dimensional video data (rendering video) corresponding to the eyesight of each user 2 is generated.

In the present embodiment, each of the client apparatuses 5 corresponds to an embodiment of the information processing apparatus according to the present technology. An embodiment of the information processing method according to the present technology is executed by the client apparatus 5.

As shown in FIG. 2, the three-dimensional space data includes scene description information and three-dimensional object data. The scene description information is also called scene description (Scene Description).

The scene description information corresponds to three-dimensional space description data that defines the configuration of the three-dimensional space (virtual space S). The scene description information includes various types of metadata for reproducing each scene of the 6DoF content.

A specific data structure (data format) of the scene description information is not limited, and an arbitrary data structure may be used. For example, glTF (GL Transmission Format) can be used as the scene description information.

The three-dimensional object data is data that defines a three-dimensional object in the three-dimensional space, that is, becomes data of each object configuring each scene of the 6DoF content. In the present embodiment, video object data and audio (voice) object data are broadcasted as the three-dimensional object data.

The video object data is data that defines a three-dimensional video object in the three-dimensional space. The three-dimensional video object is constituted of mesh (polygon mesh) data including geometry information and color information and texture data pasted on surfaces of the mesh data, or is constituted of point cloud data.

The geometry data (positions of meshes and point clouds) is expressed by a local coordinate system unique to that object. The object arrangement on the three-dimensional virtual space is designated by the scene description information.

For example, as the video object data, data of the user object 6 of each user 2 and three-dimensional video objects of other people, animals, buildings, trees, and the like is included. Alternatively, data of three-dimensional video objects of the sky, the ocean, and the like that constitute the background and the like is included. A plurality of types of objects may collectively be configured as a single three-dimensional video object.

The audio object data is constituted of positional information of a sound source and waveform data obtained by sampling voice data of each sound source. The positional information of the sound source is a position in a local coordinate system that a three-dimensional audio object group uses as a reference, and the object arrangement on the three-dimensional virtual space S is designated by the scene description information.

In the present embodiment, the broadcasting server 3 generates and broadcasts three-dimensional space data so that motions, utterances, and the like of the user 2 are reflected on the basis of the user information transmitted from each of the client apparatuses 5. For example, the video object data that defines each of the user objects 6 and a three-dimensional audio object that defines an uttered content (voice information) from each user are generated on the basis of the motion information, voice information, and the like of the user 2. In addition, the scene description information that defines the configuration of various scenes where interactions are made is generated.

As shown in FIG. 2, the client apparatus 5 arranges the three-dimensional video object and the three-dimensional audio object in the three-dimensional space on the basis of the scene description information, to thus reproduce the three-dimensional space. Then, by cutting out a video seen from the user 2 while using the reproduced three-dimensional space as a reference (rendering processing), a rendering video which is a two-dimensional video to be viewed by the user 2 is generated. It is noted that the rendering video corresponding to the eyesight of the user 2 can also be said to be a video of a viewport (display area) that corresponds to the eyesight of the user 2.

Further, by the rendering processing, the client apparatus 5 controls the headphones of the HMD 4 such that the voice expressed by the waveform data is output while the position of the three-dimensional audio object is set as the sound source position. In other words, the client apparatus 5 generates voice information to be output from the headphones and output control information for defining how to output the voice information.

The voice information is generated on the basis of the waveform data included in the three-dimensional audio object, for example. Arbitrary information that defines a sound volume, localization (localization direction) of sound, and the like may be generated as the output control information. For example, by controlling the localization of sound, an output of voice by stereophonic sound can be realized.

The rendering video, the voice information, and the output control information generated by the client apparatus 5 are transmitted to the HMD 4. The rendering video is displayed or the voice information is output by the HMD 4.

For example, when the users have a conversation or perform a dance, a cooperative activity, or the like, the three-dimensional space data on which the motions, utterances, and the like of the respective users 2 are reflected in real time is arranged from the broadcasting server 3 to the respective client apparatuses 5.

In each of the client apparatuses 5, the rendering processing is executed on the basis of the eyesight information of the user 2, and thus two-dimensional video data including the users 2 who are performing the interaction is generated. In addition, the voice information and the output control information for causing the uttered contents of the users 2 to be output from the sound source positions corresponding to the positions of the respective users 2 are generated.

By viewing the two-dimensional video displayed on the HMD 4 and the voice information output from the headphones, each of the users 2 can perform various interactions with the other users 2 in the virtual space S. As a result, the remote communication system 1 in which interactions can be made with other users is realized.

A specific algorithm or the like for realizing the virtual space S in which the interactions can be made with other users 2 is not limited, and various technologies may be used. For example, it is also possible to motion-capture, on the basis of an avatar model that has been captured and rigged in advance as the video object data that defines the user object 6 of each of the users 2, real-time motions of the user and move the user object 6 by bone animation.

Other than this pattern, for example, a pattern in which the user 2 is captured in real time while being surrounded by a plurality of video cameras, and then a 3D model of that instant is generated by photogrammetry is also possible. In this case, the user information transmitted from the client apparatus 5 to the broadcasting server 3 may include real-time 3D modeling data of oneself. Further, in a case where this pattern is adopted, the 3D model of oneself is transmitted to the broadcasting server 3 for broadcasting to the other users 2. On the other hand, during rendering, it is also possible to use the captured image as it is without causing the 3D model that has been transmitted to the broadcasting server 3 to be broadcasted again by the broadcasting server 3. Thus, it becomes possible to prevent a broadcasting delay of three-dimensional space data and the like from occurring.

### [Discussion on Processing Resources for Constructing Virtual Space S]

As exemplified in FIGS. 1 and 2, in 6DoF video broadcasting that provides a viewing experience at fee viewpoint positions, various things that appear in the virtual space S are constituted of 3D objects such as meshes and point clouds for enabling viewing to be performed from all positions. Data of those 3D video objects is broadcasted together with the scene description information (Scene Description file) that manages scene information that indicates where to arrange in the virtual space S, or the like. The user 2 can freely move within the virtual space S and view at any favorable position.

Recently, in the name of metaverse, bidirectional remote communication in which a motion of oneself is captured, and that motion is reproduced via an avatar (3D video object) existing in the virtual space S, to thus enable not only one-way viewing but also various interactions ranging from basic communication such as a conversation or exchange of gestures with another user 2 to cooperative activities such as a dance in which motions are made in sync and carrying a heavy object together, is gaining attention.

It is considered that in such a virtual space S, there is still more room for improvement in terms of reality, that is, quality of appearance of avatars, fidelity in reproducing motions of human beings, and the like. In the future, a true metaverse that reproduces a virtual space that is almost real and cannot be distinguished from the real space, realizes exchange of natural interactions as if oneself is in the same space as a person at a remote location, and the like, is expected to be realized.

For realization of such a true metaverse, it becomes important to project expressions, motions, and lip movements of users in real time to give credibility to the avatars. This requires an awful amount of data to be transmitted without a time lag for all of the users 2 existing in the virtual space S and to be processed in real time. Even a small delay causes reality to be impaired and the user 2 to feel a sense of discomfort.

In this manner, it is considered that an awful amount of computing resources are requisite for processing all pieces of data in real time without impairing reality. While strengthening of computing, network infrastructures, and the like is being discussed, it cannot be said that there are sufficient resources for pursuing true realism. Accordingly, it becomes very important to perform optimal resource distribution so as to suppress processing resources without impairing the realism that the users 2 feel.

The present inventors have repeatedly discussed about the construction of the virtual space S having high reality. Hereinafter, descriptions will be given on that discussed contents and a technology newly devised by the discussion.

As a resource distribution method, there is a method in which a plurality of pieces of LOD (Level of Detail) data are given with respect to one 3D video object, and the data is switched according to a distance from the viewpoint position of the user 2 to that video object. This method can be said to be a technology that suppresses the processing resources without impairing the realism that the users 2 feel, while focusing on the point that even when a resolution of a video object at a distant position is suppressed, a person does not realize it.

In the remote communication that uses bidirectional communication instead of one-way communication as in the metaverse, a target that the user 2 is exchanging an interaction with becomes an attention target object that becomes a target of the attention for the user 2 irrespective of whether or not the user 2 is looking at that target.

Since it becomes necessary to realize a smooth interaction with no sense of discomfort with that attention target object, it becomes important to allocate many processing resources to this interaction partner in the viewpoint of attaining both high image quality and low latency, to thus perform efficient resource distribution (largely affects the realism that the users 2 feel).

Meanwhile, this attention target object which becomes the interaction partner communicates by using gestures such as waving a hand from a distant position, or the like, and is thus not necessarily limited to the case of being close to the position of the user 2. In other words, a case where the avatar of another user 2 positioned far from the user 2, or the like becomes the attention target object that becomes the interaction partner is also quite conceivable.

In such a case, with the method of performing the resource distribution with respect to one 3D video object in accordance with only the distance from the user 2, it becomes difficult to allocate appropriate processing resources to the interaction partner.

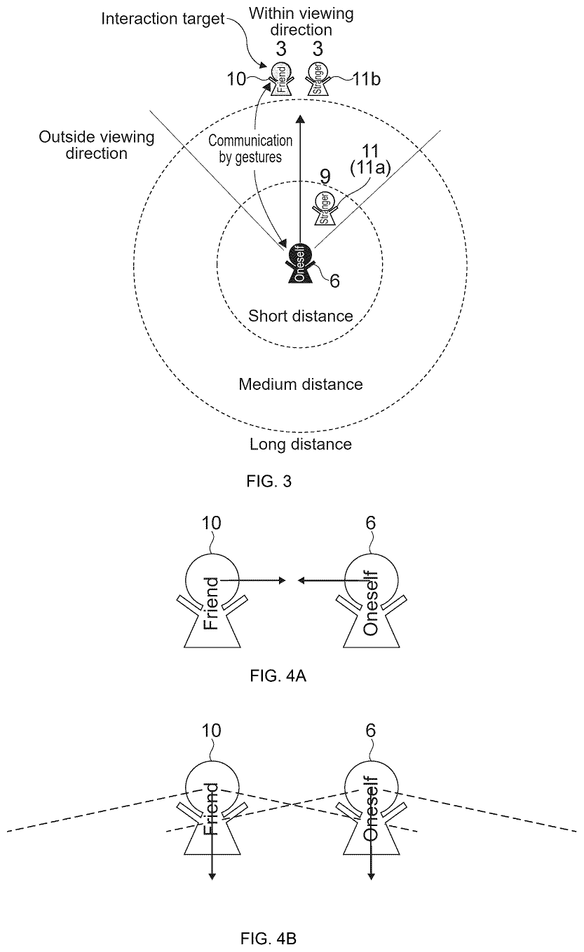

For example, as exemplified in FIG. 3, it is assumed that a scene where gestures are exchanged with an avatar (will be referred to as friend object) 10 of a friend at a distant position from the user 2 (user object 6) is constructed. In this scene, an avatar (will be referred to as stranger object) 11a of a stranger at a close position and a stranger object 11b at a distant position are also present.

In the example shown in FIG. 3, by the method of performing the resource distribution according to only the distance from the user object 6, the same processing resources are allocated to the friend object 10 and the stranger object 11b at the distant positions. Hereinafter, descriptions will be given while expressing the processing resources to be allocated to the respective three-dimensional video objects by scores.

In the example shown in FIG. 3, a distribution score “3” of the processing resources is set to both the friend object 10 and the stranger object 11b at the distant positions. On the other hand, a distribution score “9” of the processing resources is set for the stranger object 11a at the close position.

In this manner, the friend object 10 as the interaction target with which the interaction is made can only be allocated with the same processing resources as the stranger object 11b as a non-interaction target with which no interaction is made.

If the processing resources allocated to the friend object 10 are used preferentially in low-latency processing for performing interactions without a delay, the image quality will be deteriorated more than the stranger object 11b positioned next to the friend object 10. Moreover, if high-quality picture processing is prioritized with respect to the friend object 10, a delay occurs in a reaction of a motion or the like of the friend object 10 that becomes the interaction partner, and thus a smooth interaction cannot be performed. In other words, by the method of performing the resource distribution according to only the distance from the user object 6, realism in either the resolution in the appearance or real time in the interaction is impaired.

In remote communication just like in real life, a low latency is considered to be essential like air, and when a delay occurs before the avatar of the partner reacts, a sense of discomfort is caused due to lack of realism. In online games and the like, there may be adopted a technology in which, by performing display while predicting where a player moves to some extent, a perceivable delay is eliminated even when a latency is caused.

A technology for predicting realistic motions of human beings instead of those of games is also being developed, and thus it becomes important to allocate resources to such low-latency processing for reflecting a motion of that instant of a friend user at a distant location in real time in the real world.

Meanwhile, regarding the stranger object 11 that is a non-interaction target that does not involve with the user 2, even when a motion thereof is not reflected in real time, the user 2 will not notice that a delay has occurred. Accordingly, even if the processing resources are not allocated to the low-latency processing, the realism that the user feels is not impaired.

Also from the viewpoints as described above, in the remote communication space like the metaverse, appropriately determining the interaction target and allocating many processing resources becomes very important in performing optimal resource distribution in which the processing resources are suppressed without impairing the realism that the user 2 feels.

As another method for the resource distribution, there is a method of determining an action that a user will take next and a partner of that action, and allocating many resources to the action partner. However, also in the real world, there are various types and forms in the interactions to be made with a partner. For example, there is an interaction that is made while constantly making an eye-to-eye contact, an interaction that is made while saying something to each other, and an interaction in which it is obvious that the two are aware of each other when seen from outside.

Without being limited to such interactions, there is also an interaction of acting together toward a single goal while feeling the presence of each other without looking at or saying something to the partner. For example, in a dance that largely uses a large stage, or the like, the users may dance at a close distance while looking at each other, or a case where the users construct one piece of work by dancing together at ends of the stage without looking at each other is entirely possible.

Further, there may also be a case where, while the users work silently using tools such as instruments and paint from distant positions, the results of their work construct one piece of work. Furthermore, there may also be a case where the plurality of users 2 complete a product such as clothing while silently working on respective parts.

In other words, the interaction may be constituted of various actions including, in addition to the mutual actions with respect to oneself and the partner, individual actions that are made without looking at the partner, for executing the work with the partner. Accordingly, there may be a case where the determination on the presence or absence of an action with respect to each user 2 and the partner to be the action target does not necessarily match with the determination on the presence or absence of an interaction and the interaction target.

For example, for each action made with respect to the user 2, another user 2 who is included in the eyesight or is positioned at the central visual field is determined as the action partner. Further, it is assumed that the method of allocating many processing resources to the another user object 7 corresponding to the another user 2 is adopted. In such a case, when an interaction in which the partner may move out of the eyesight or the central visual field in midstream is made, it becomes difficult to continuously determine the interaction target and appropriately allocate the processing resources.

FIG. 4 are schematic diagrams showing an example of a case where the processing resource distribution is simulated by the method of allocating many resources to the partner of an action to perform next. Herein, with respect to the action of the user 2 (user object 6), the another user 2 (friend object 10) positioned at the central visual field is determined as the action partner.

As shown in FIGS. 4, in the interaction of dancing in sync with the friend object 10, the first scene shown in A of FIG. 4 is a scene in which they say “let's dance together”. Herein, since the action of talking while looking at each other is taken, the partner is recognized as the action target for both the user object 6 and the friend object 10, and the processing resources are thus allocated. Accordingly, seamless exchange of conversations is realized.

The next scene shown in B of FIG. 4 is a scene where the two dance while facing front, and the two mutually move out of the central visual fields. Accordingly, in the scene shown in B of FIG. 4, the two cannot be mutually specified as the action targets, and appropriate processing resources cannot be allocated to the partner. As a result, a delay is caused in the motion of the partner, and it becomes difficult to dance in sync. In this manner, when executing the determination of the action target, a case where the partner will no longer be determined as the action target even during the interaction may occur.

Without being limited to the example of the dance shown in FIGS. 4, in a cooperative activity of carrying a heavy object such as a desk together, or the like, for example, carrying while basically facing a carrying direction and, also in the conversation or the like, moving the line of sight during the conversation occur naturally. In this manner, an interaction with a partner is not always made while constantly looking at the partner. In addition, since the interaction continues even during that period, if the allocation of the resources is not continued, a delay is caused in the motion of the partner, and interactions cannot be exchanged smoothly.

The inventors have devised a new technology regarding the optimal processing resource distribution on the basis of such discussion results. Hereinafter, the present technology that has been newly devised will be described in detail.

### [Interaction Starting Predictive Behavior Determination and Interaction Ending Predictive Behavior Determination]

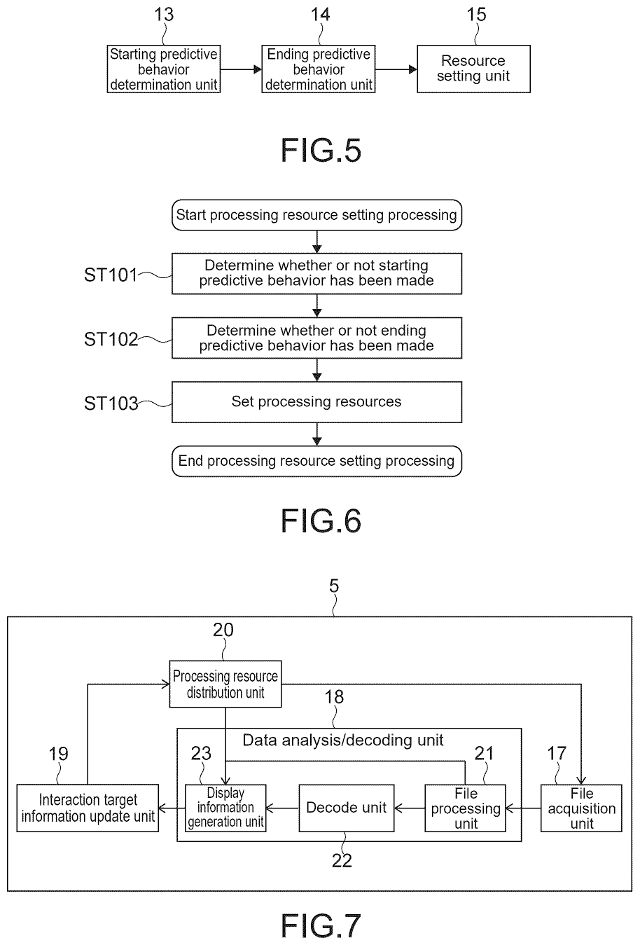

FIG. 5 is a schematic diagram showing a basic configuration for realizing a processing resource setting according to the present technology.

FIG. 6 is a flowchart showing basic operations in the processing resource setting according to the present technology.

As shown in FIG. 5, in the present embodiment, a starting predictive behavior determination unit 13, an ending predictive behavior determination unit 14, and a resource setting unit 15 are constructed for setting the processing resources to be used in the processing for improving reality of two-dimensional video data.

Each block shown in FIG. 5 is realized by the processor of the client apparatus 5 such as a CPU executing a program (e.g., application program) according to the present technology. In addition, the information processing method shown in FIG. 6 is executed by these functional blocks. It is noted that dedicated hardware such as an IC (integrated circuit) may be used as appropriate for realizing the respective functional blocks.

The starting predictive behavior determination unit 13 determines, with respect to the another user object 7 that is a virtual object corresponding to the another user in the three-dimensional space (virtual space S), presence or absence of a starting predictive behavior that becomes a sign to start an interaction with the user 2 (Step 101).

The ending predictive behavior determination unit 14 determines, with respect to the interaction target object that is the another user object 7 that has been determined as having taken the starting predictive behavior, presence or absence of an ending predictive behavior that becomes a sign to end the interaction (Step 102).

The resource setting unit 15 sets, with respect to the interaction target object, the processing resources that are used in the processing for improving reality to be relatively high until it is determined that the ending predictive behavior has been taken (Step 103).

It is noted that the specific processing resource amount (score) that is determined as “relatively high” only needs to be set as appropriate when constructing the remote communication system 1. For example, a usable processing resource amount is defined, and a relatively-high processing resource amount only needs to be set when distributing that processing resource amount.

In this manner, in the present technology, the presence or absence of the interaction starting predictive behavior that is a behavior with which a start of an interaction is predicted and the presence or absence of the interaction ending predictive behavior that is a behavior with which an end of the interaction is predicted are determined. The optimal processing resource distribution is realized on the basis of the determination results of these determination processing.

It is noted that the starting predictive behavior determination and the ending predictive behavior determination are determined on the basis of the user information related to each user 2. For example, when seen from the user 2a shown in FIG. 1, the presence or absence of the starting predictive behavior and the presence or absence of the ending predictive behavior are determined on the basis of the user information of the user 2a and the user information of each of the other users 2b and 2c.

As the user information related to each user 2, the user information shown in FIG. 1 that is transmitted from each client apparatus 5 to the broadcasting server 3 may be used, for example. In this case, for example, other user information used in the starting predictive behavior determination and the ending predictive behavior determination is transmitted from the broadcasting server 3 to each client apparatus 5.

Alternatively, the user information of each user 2 may be acquired by analyzing three-dimensional space data on which the user information of each user 2 is reflected and which is broadcasted from the broadcasting server 3 by each of the client apparatuses 5. Other methods of acquiring the user information of each user 2 are not limited.

Hereinafter, first to third embodiments will be described as specific embodiments to which the processing resource setting that uses the starting predictive behavior determination and the ending predictive behavior determination shown in FIGS. 5 and 6 is applied.

### First Embodiment

FIG. 7 is a schematic diagram showing a configuration example of the client apparatus 5 according to the first embodiment.

In the present embodiment, the client apparatus 5 includes a file acquisition unit 17, a data analysis/decoding unit 18, an interaction target information update unit 19, and a processing resource distribution unit 20. Further, the data analysis/decoding unit 18 includes a file processing unit 21, a decode unit 22, and a display information generation unit 23.

The respective blocks shown in FIG. 7 are realized by the processor of the client apparatus 5 such as the CPU executing the program according to the present technology. Of course, dedicated hardware such as an IC may be used as appropriate for realizing the respective functional blocks.

The file acquisition unit 17 acquires three-dimensional space data (scene description information and three-dimensional object data) broadcasted from the broadcasting server 3. The file processing unit 21 executes an analysis of the three-dimensional space data and the like. The decode unit 22 executes decode (decoding) of video object data, audio object data, and the like that are acquired as the three-dimensional object data. The display information generation unit 23 executes the rendering processing shown in FIG. 2.

The interaction target information update unit 19 determines the presence or absence of the starting predictive behavior and the presence or absence of the ending predictive behavior with respect to the another user object 7 in each scene constituted of the virtual space S. In other words, in the present embodiment, the starting predictive behavior determination unit 13 and the ending predictive behavior determination unit 14 shown in FIG. 5 are realized by the interaction target information update unit 19. In addition, the determination processing of Steps 101 and 102 shown in FIG. 6 is executed by the interaction target information update unit 19.

It is noted that the starting predictive behavior determination and the accommodation predictive behavior determination are executed on the basis of the user information (another user information) acquired by the analysis or the like on the three-dimensional space data that is executed by the file processing unit 21, for example. Alternatively, it is also possible to use the user information acquired as a result of the rendering processing executed by the display information generation unit 23. Furthermore, it is also possible to use the user information output from each of the client apparatuses 5 as shown in FIG. 1.

The processing resource distribution unit 20 distributes, with respect to the another user object 7, the processing resources to be used in the processing for improving reality in each scene constituted of the virtual space S. In the present embodiment, as the processing resources to be used in the processing for improving reality, the processing resources to be used in the high-quality picture processing for improving visual reality and the processing resources to be used in the low-latency processing for improving responsive reality in the interaction are distributed as appropriate.

It is noted that the high-quality picture processing can also be referred to as processing for displaying an object with high image quality. In addition, the low-latency processing can also be referred to as processing for reflecting a motion of an object with a low latency.

Further, the low-latency processing includes arbitrary processing for reducing a delay that is required before a motion at that instant of another user 2 at a remote location is reflected on the partner user 2 in real time (delay from capture to transmission and rendering). For example, processing of predicting a motion of the user 2 that is to be taken during the coming delay time and reflecting the prediction result on a 3D model, or the like is also included in the low-latency processing.

In other words, in the present embodiment, the resource setting unit 15 shown in FIG. 5 is realized by the processing resource distribution unit 20. In addition, the setting processing of Step 103 shown in FIG. 6 is executed by the processing resource distribution unit 20.

### [Specific Example of Interaction Starting Predictive Behavior]

The interaction starting predictive behavior is a behavior that becomes a sign to start an interaction between the another user object 7 and the user 2. When an avatar of oneself (user object 6) is displayed as in the virtual space S shown in FIG. 1, the behavior that becomes a sign to start an interaction between the user object 6 and the another user object 7 is determined as the interaction starting predictive behavior.

For example, it is possible to define the behaviors indicated below as the interaction starting predictive behavior on the basis of the behavior pattern of “while a partner may go out of eyesight during an interaction, exchange while facing the partner will be performed once for sure at the start of the interaction” from the content of [Non-Patent Literature 1] described above.

For example, behaviors such as “the another user object 7 responding to, by an interaction-related behavior, an interaction-related behavior that has been performed by the user object 6 with respect to the another user object 7”, “the user object 6 responding to, by the interaction-related behavior, the interaction-related behavior that has been performed by the another user object 7 with respect to the user object 6”, and “the user object 6 and the another user object 7 mutually performing the interaction-related behavior” can be defined as the interaction starting predictive behavior. In other words, by analyzing whether or not these behaviors are being taken, it becomes possible to determine the start of the interaction and the partner thereof.

The “interaction-related behavior” is a behavior related to the interaction and can be defined by, for example, “uttering while looking at a partner”, “performing a predetermined gesture while looking at the partner”, “touching the partner”, “touching the same virtual object that the partner is touching”, and the like. “Touching the same virtual object that the partner is touching” includes, for example, the cooperative activity of carrying a heavy object such as a desk together, and the like.

It is noted that “touching the partner” and “touching the same virtual object that the partner is touching” can also be collectively expressed as “touching a body”. In other words, “directly touching a body of a partner with a part of a body of oneself such as a hand” and “performing an indirect contact of carrying a certain object together or the like” can also be collectively expressed as “touching a body”.

The presence or absence of these “interaction-related behaviors” can be determined by the voice information, motion information, contact information, and the like that are acquired as the user information related to each user 2. In other words, the presence or absence of the “interaction-related behavior” can be determined on the basis of the eyesight information of the user, the motion information of the user, the voice information of the user, the contact information of the user, the eyesight information of the another user, the motion information of the another user, the voice information of the another user, the contact information of the another user, and the like.

In other words, the presence or absence of the interaction starting predictive behavior can be determined on the basis of the user information (another user information) related to each user 2.

It is noted that what kind of behavior is to be defined as the interaction starting predictive behavior is not limited, and other arbitrary behaviors may also be defined. For example, behaviors such as “the user object 6 performing the interaction-related behavior with resect to the another user object 7” and “the another user object 7 performing the interaction-related behavior with respect to the user object” may also be defined as the interaction starting predictive behavior.

One of the plurality of behaviors exemplified as the interaction starting predictive behavior may be adopted, or a plurality of behaviors including an arbitrary combination may be adopted. For example, what kind of behavior is to be defined as the interaction starting predictive behavior regarding the contents of scenes and the like can be defined as appropriate.

Similarly, one of the plurality of behaviors exemplified above may be adopted, or a plurality of behaviors including an arbitrary combination may be adopted as the “interaction-related behavior”. For example, what kind of behavior is to be defined as the interaction-related behavior regarding the contents of scenes and the like can be defined as appropriate.

### [Specific Example of Interaction Ending Predictive Behavior]

The interaction ending predictive behavior is a behavior that becomes a sign to end an interaction between the another user object 7 that is the interaction target object and the user 2. When an avatar of oneself (user object 6) is displayed as in the virtual space S shown in FIG. 1, the behavior that becomes a sign to end an interaction between the user object 6 and the another user object 7 is determined as the interaction ending predictive behavior.

For example, it is possible to define the behaviors indicated below as the interaction ending predictive behavior on the basis of the behavior pattern of “a person can continue an interaction without looking at a partner on the basis of the presence of the partner (an ability of a target to draw attention toward oneself). That is, when ending the interaction, a person is in a state where attention cannot be directed toward the partner or a person stops the behavior of drawing attention” from the content of [Non-Patent Literature 2] described above.

For example, behaviors such as “moving away while being mutually out of eyesight of a partner”, “an elapse of a certain time while being mutually out of the eyesight of the partner and taking no action with respect to the partner”, and “an elapse of a certain time while being mutually out of a central visual field of the partner and taking no visual action with respect to the partner” can be defined as the interaction ending predictive behavior. In other words, by analyzing whether or not these behaviors are being taken, it becomes possible to determine the end of the interaction.

It is noted that the “action with respect to the partner” includes, for example, various actions that can be taken from outside the eyesight, such as speaking and touching a body. Of those, the “visual action with respect to the partner” includes arbitrary actions that can be used to visually appeal the presence with respect to the partner, such as various gestures and dances.

By defining the behaviors as described above as the interaction ending predictive behavior, in a case where the partner is taking a behavior of appealing presence (attention) even during a period in which one is not facing the partner, for example, it becomes possible to continue the determination as the interaction target object and thus execute the processing resource distribution with high accuracy.

The presence or absence of the interaction ending predictive behavior can be determined by the voice information, motion information, contact information, and the like that are acquired as the user information related to each user 2. In other words, the presence or absence of the interaction ending predictive behavior can be determined on the basis of the eyesight information of the user, the motion information of the user, the voice information of the user, the contact information of the user, the eyesight information of the another user, the motion information of the another user, the voice information of the another user, the contact information of the another user, and the like. In addition, the elapse of a certain time can be determined on the basis of time information.

It is noted that what kind of behavior is to be defined as the interaction ending predictive behavior is not limited, and other behaviors may also be defined. One of the plurality of behaviors exemplified as the interaction ending predictive behavior may be adopted, or a plurality of behaviors including an arbitrary combination may be adopted. For example, what kind of behavior is to be defined as the interaction ending predictive behavior regarding the contents of scenes and the like can be defined as appropriate.

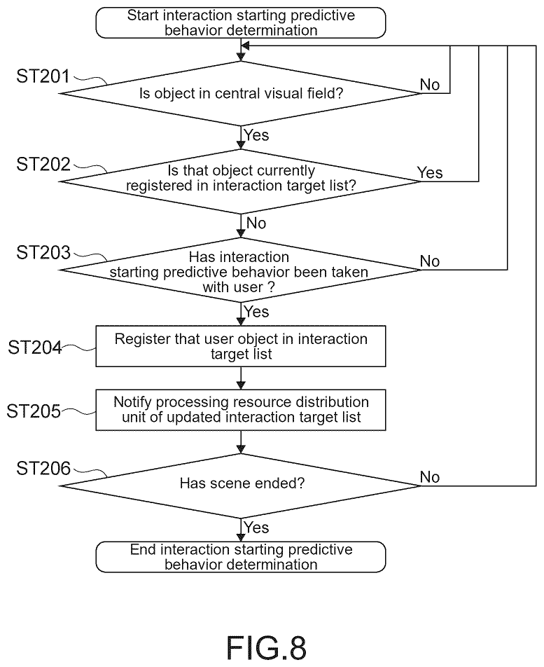

FIG. 8 is a flowchart showing an example of the starting predictive behavior determination according to the present embodiment.

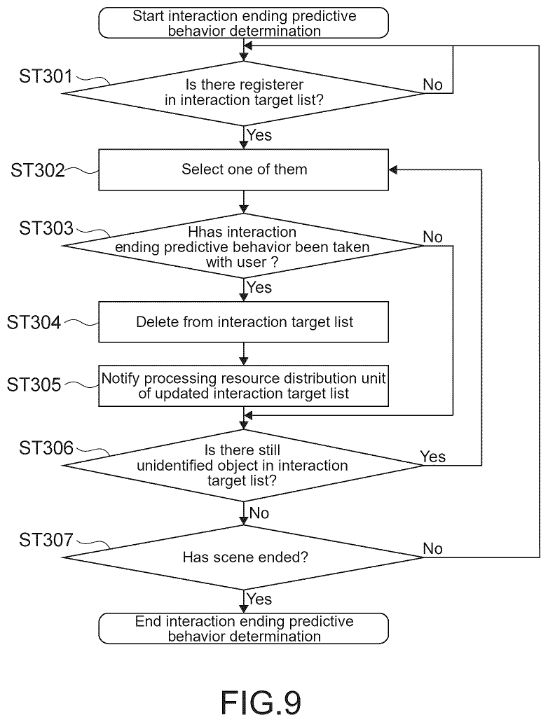

FIG. 9 is a flowchart showing an example of the ending predictive behavior determination according to the present embodiment.

The determination processing exemplified in FIGS. 8 and 9 is repetitively executed at a predetermined frame rate. Typically, each of the determination processing shown in FIGS. 8 and 9 is executed in sync with the rendering processing, though of course is not limited to such processing.

The determination on whether or not a scene has ended in Step 206 shown in FIG. 8 and Step 307 shown in FIG. 9 is executed by the file processing unit 21 shown in FIG. 7. Other steps are executed by the interaction target information update unit 19.

In the starting predictive behavior determination, first, whether or not another user object 7 is present in the central visual field seen from the user 2 is monitored (Step 201). This processing is processing that has been set on the premise of the behavior pattern that “exchange while facing the partner will be performed once for sure at the start of the interaction”.

When the another user object 7 is present in the central visual field (Yes in Step 201), it is determined whether or not the object is currently registered in an interaction target list (Step 202).

In the present embodiment, the interaction target list is generated and managed by the interaction target information update unit 19. The interaction target list is a list in which other user objects 7 that have been determined as the interaction target objects are registered.

When the another user object 7 present in the central visual field is already registered in the interaction target list (Yes in Step 202), the processing returns to Step 201. When the another user object present in the central visual field is not registered in the interaction target list (No in Step 202), the presence or absence of the starting predictive behavior with the user 2 (user object 6) is determined (Step 203).

When there is no interaction starting predictive behavior with the user object 6 (No in Step 203), the processing returns to Step 201. When there is an interaction starting predictive behavior with the user object 6 (Yes in Step 203), the object is registered in the interaction target list as the interaction target object (Step 204).

The updated interaction target list is notified to the processing resource distribution unit 20 (Step 205). The interaction starting predictive behavior determination is repetitively executed until the scene ends. Then, when the scene ends, the interaction starting predictive behavior determination is ended (Step 206).

It is noted that the step of determining whether or not the scene has ended, that is shown in FIG. 8, can alternatively be replaced by a determination on whether or not the user 2 will end the usage of the present remote communication system 1 or a determination on whether or not a predetermined content stream is to be ended.

As shown in FIG. 9, in the ending predictive behavior determination, whether or not registerers are in the interaction target list is monitored (Step 301). When there are registerers (Yes in Step 301), one of them is selected (Step 302).

The presence or absence of the ending predictive behavior with the user 2 (user object 6) is determined (Step 303). When the ending predictive behavior is taken (Yes in Step 303), it is determined that the interaction is to be ended, and the object is deleted from the interaction target list (Step 304).

The updated interaction target list is notified to the processing resource distribution unit 20 (Step 305), and whether or not there is an unidentified object in the interaction target list is determined (Step 306). It is noted that when it is determined that no ending predictive behavior has been taken in Step 303 (No in Step 303), the processing advances to Step 306 without deleting the object from the interaction target list.

In Step 306, whether or not an unidentified object is still in the interaction target list is determined. When an unidentified object is still in the list (Yes in Step 306), the processing returns to Step 302. In this manner, the interaction ending predictive behavior determination is executed for all of the objects registered in the interaction target list.

The interaction ending predictive behavior determination is repetitively executed until the scene ends. Then, when the scene ends, the interaction ending predictive behavior determination is ended (Step 307).

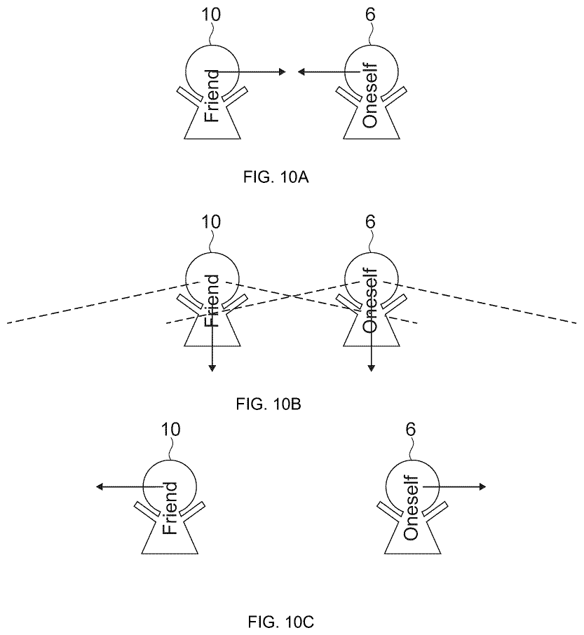

FIG. 10 are each a schematic diagram for explaining a specific application example of the processing resource distribution according to the present embodiment. Herein, a case where the present technology is applied to an interaction of dancing in sync with the friend object 10 will be described.

The first scene shown in A of FIG. 10 is a scene where they say “let's dance together” to each other. Herein, the “interaction-related behavior” in which they mutually utter while looking at the partner is performed. Accordingly, this corresponds to one of “the another user object responding to, by the interaction-related behavior, the interaction-related behavior that has been performed by the user object with respect to the another user object”, “the user object responding to, by the interaction-related behavior, the interaction-related behavior that has been performed by the another user object with respect to the user object”, or “the user object and the another user object mutually performing the interaction-related behavior”, and thus it is determined that the interaction starting predictive behavior has been taken.

Accordingly, by the interaction starting predictive behavior determination processing shown in FIG. 8, it becomes possible to mutually register the partner in the interaction target list and set relatively-high processing resources to the dance partner.

The next scene shown in B of FIG. 10 is a scene where the two dance while facing front and are mutually out of the central visual fields. By the method of determining the action target that has been described with reference to FIGS. 4, there has been a possibility that in the scene shown in B of FIG. 4, the two will not be able to specify each other as the action target, and thus appropriate processing resources will not be allocated to the partner.

Meanwhile, in the present interaction starting predictive behavior determination, although the two are mutually out of the central visual field of the partner, the visual action by the dance is attracting attention of the user 2 via a peripheral visual field. Therefore, in Step 303 of FIG. 9, it is determined that there is no interaction ending predictive behavior and that the interaction is continuing.

As a result, it becomes possible to set relatively-high processing resources to the partner continuously from the scene shown in A of FIG. 10. Consequently, a highly-accurate interaction of dancing in sync without a delay in the motion of the partner is realized.

Of course, what kind of behavior is to be defined as the interaction ending predictive behavior is important. Herein, “an elapse of a certain time while being mutually out of a central visual field of a partner and taking no visual action with respect to the partner” that has been exemplified above is set as the interaction ending predictive behavior. As a result, also in the dance scene shown in B of FIG. 10, it becomes possible to determine that the interaction is continuing and set relatively-high processing resources to the dance partner.

C of FIG. 10 is a scene where the dance is ended and the two break up. The two are moving in directions they wish without minding the presence of the partner in particular. In the scene exemplified in C of FIG. 10, it is determined in Step 303 of FIG. 9 that the interaction ending predictive behavior has been taken, and the two mutually delete the partner from the interaction target list. In other words, it is determined that this interaction with the friend object 10 has ended, and the setting of relatively-high processing resources as the interaction target object is canceled.

In this manner, with the processing resource distribution method that uses the starting predictive behavior determination and the ending predictive behavior determination according to the present embodiment, it is possible to appropriately and continuously determine the interaction target including the interaction based on presence that continues even when the partner is out of eyesight. As a result, it becomes possible to realize an optimal processing resource distribution in which the processing resources are suppressed without impairing the realism that the user 2 feels.

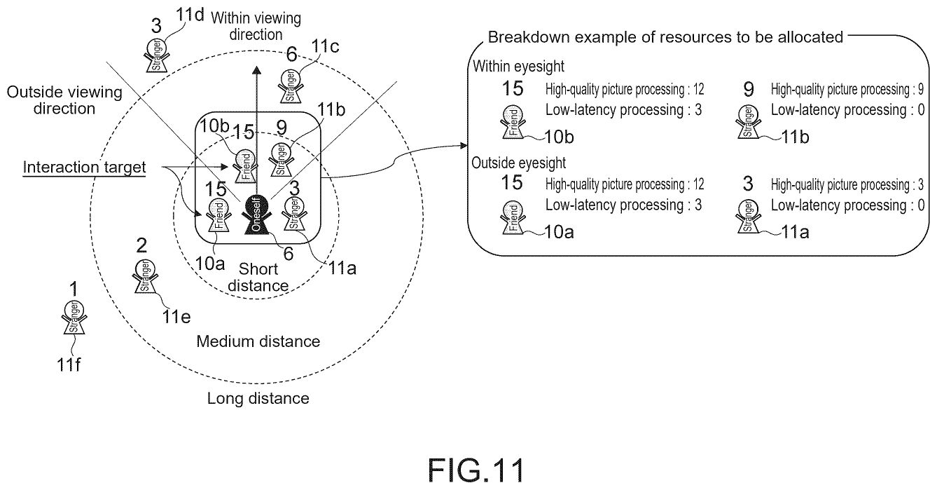

FIG. 11 is a schematic diagram for explaining an embodiment in which the determination of an interaction target that uses the starting predictive behavior determination and the ending predictive behavior determination according to the present embodiment and the processing resource distribution that uses the distance from the user 2 (user object 6) and the viewing direction are combined.

The example shown in FIG. 11 shows a scene where the user object 6 of oneself, the friend objects 10a and 10b that are the other user objects, and stranger objects 11a to 11f that are also the other user objects are displayed.

Of the other user objects, the friend objects 10a and 10b are determined as the interaction target objects. Other stranger objects 11a to 11f are determined as non-interaction target objects.

In the example shown in FIG. 11, a distribution score of the low-latency processing is set to “0” for all of the stranger objects 11a to 11f that are the non-interaction target objects. Regarding these stranger objects 11a to 11f having no involvement in particular, since realism cannot be obtained if the objects are at a short distance but are not displayed with high definition in the viewpoint of image quality, a distribution corresponding to the distance is set for the resource distribution to the high-quality picture processing.

Meanwhile, in the viewpoint of real time, the non-interaction objects are not involved in particular. Accordingly, even when the motions of the stranger objects 11a to 11f are delayed with respect to the actual motions, the user 2 does not know the actual motions of the stranger objects 11a to 11f and thus will not notice that delay.

In the present embodiment, it is possible to appropriately determine whether or not the other user objects are the interaction targets. Accordingly, it becomes possible to realize an extreme resource reduction in which the distribution score of the low-latency processing is set to “0” with respect to the non-interaction target objects (stranger objects 11a to 11f) without impairing the realism that the user 2 feels.

As shown in FIG. 11, the processing resources that have been reduced with respect to the stranger objects 11a to 11f that are the non-interaction target objects can be allocated to the two friend objects 10a and 10b that are the interaction target objects. Specifically, “3” is allocated as the distribution score of the low-latency processing. In addition, “12” is allocated as the distribution score of the high-quality picture processing and is thus set to be larger than the stranger object 11b that is at the same short distance and is within eyesight by “3”.

Further, it is assumed that three people including the friend object 10a positioned outside the eyesight at a current time point, that is, oneself and two friend objects 10a and 10b, are having a conversation. In this case, the user 2 is highly likely to direct the eyesight toward the friend object 10a right outside the eyesight. Moreover, there is also a possibility that the friend object 10a outside the eyesight will take a reaction to enter the eyesight of the user 2.

In the present embodiment, the friend object 10a outside the eyesight can also be determined as the interaction target object, so a relatively-high resource distribution score of “15” that is the same as that of the friend object 10b within the eyesight is allocated. As a result, even when a motion of the user 2 to direct the eyesight toward the friend object 10b outside the eyesight or a motion of the friend object 10b outside the eyesight to enter the eyesight of the user 2 is made, a scene can be reproduced without impairing the realism.

The combination of the determination of the interaction target object that uses the starting predictive behavior determination and the ending predictive behavior determination and the processing resource distribution that is based on other parameters such as the distance from the user 2 as exemplified in FIG. 11 is also included in an embodiment of the processing resource setting that uses the starting predictive behavior determination and the ending predictive behavior determination according to the present technology.

Of course, the example shown in FIG. 11 is one example, and various other variations may also be applied. For example, specific settings on how to distribute the processing resources to the respective objects, and the like may be set as appropriate according to contents of implementation.

Further, as shown in FIG. 7, in the present embodiment, the result of the processing resource distribution is output from the processing resource distribution unit 20 to the file acquisition unit 17. For example, models having different definition, such as a high-definition model and a low-definition model, are prepared as the models to be acquired as the three-dimensional video objects. Then, the model to be acquired is switched according to the resource distribution of the high-quality picture processing. For example, it is also possible to execute such processing of switching the models having different definition as an embodiment of the processing resource setting that uses the starting predictive behavior determination and the ending predictive behavior determination according to the present technology.

So far, in the remote communication system 1 according to the present embodiment, each of the client apparatuses 5 determines the presence or absence of the starting predictive behavior and the presence or absence of the ending predictive behavior with respect to the another user object 7 in the three-dimensional space (virtual space S). Then, with respect to the interaction target object that has been determined as having taken the starting predictive behavior, the processing resources to be used in the processing for improving reality are set to be relatively high until it is determined that the ending predictive behavior has been taken. Thus, it becomes possible to realize a high-quality bidirectional virtual space experience that realizes a smooth interaction with the another user 2 at a distant location.

In the present remote communication system 1, each of the presence or absence of the interaction starting predictive behavior and the presence or absence of the interaction ending predictive behavior is determined on the basis of the user information related to each user 2. Thus, it becomes possible to determine the interaction target object that requires many processing resources with high accuracy and determine the end of the interaction in the truest sense with high accuracy.

As a result, it becomes possible to appropriately determine an interaction execution period during which the interaction is made and realize an optimal processing resource distribution on the basis of that determination result. For example, for example, even when the interaction partner goes out of the central visual field or goes out of the eyesight, it becomes possible to continuously determine the partner as the interaction partner and continuously and appropriately distribute the processing resources during the interaction execution period.

By applying the present technology, in the Volumetric remote communication, it becomes possible to appropriately determine the interaction target which becomes very important in terms of the realism that the user 2 feels, and perform an optimal resource distribution in which the processing resources are suppressed without impairing the realism that the user 2 feels even under the environment with limited computing resources.

### Second Embodiment

A remote communication system according to the second embodiment will be described.

In descriptions hereinafter, descriptions on parts that are similar to the configurations and operations of the remote communication system described in the embodiment above will be omitted or simplified.

By the processing resource distribution method described in the first embodiment, it has become possible to appropriately determine the interaction target object and allocate many processing resources to the interaction target object.

Here, through further considerations, the inventors have discussed about an importance degree of the user 2 with respect to the interaction target object. For example, even in the case of the same interaction target object, the importance degree for the user 2 differs between an object of a best friend (best-friend object) that constantly acts together and an object of a person met for the first time (newly-met object) who just happened to speak to ask for directions.

Further, the importance degree for the user 2 may also differ with respect to the non-interaction target objects. In other words, even in the case of the same non-interaction target, the importance degree of the user 2 differs between a stranger object that just passes by and a friend object that is currently not performing an interaction but is highly likely to perform an interaction thereafter.

The inventors have newly devised a processing resource distribution that takes into account such a difference in importance degree for the user 2 between the interaction target objects or between the non-interaction target objects.

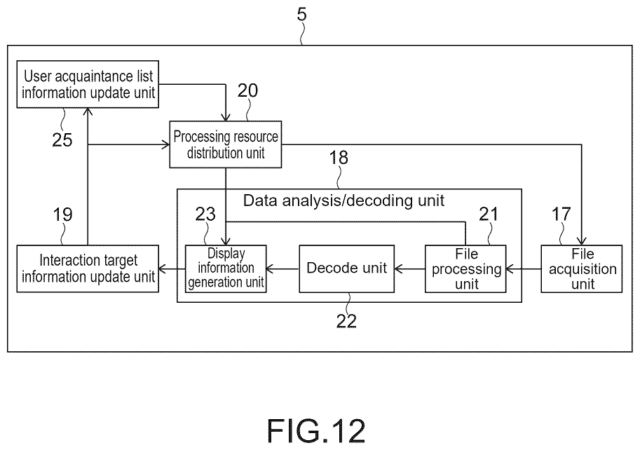

FIG. 12 is a schematic diagram showing a configuration example of the client apparatus 5 according to the second embodiment.

In the present embodiment, the client apparatus 5 further includes a user acquaintance list information update unit 25.

The user acquaintance list information update unit 25 registers the another user object 7 that has become the interaction target object even once in a user acquaintance list as an acquaintance of the user 2. Then, a closeness level of the another user object 7 with respect to the user object 6 is calculated and recorded in the user acquaintance list. It is noted that the closeness level can also be referred to as the importance degree for the user 2 and corresponds to an embodiment of a friendship level according to the present technology.

For example, the closeness level can be calculated from the number of times an interaction is made up to the current time point, an accumulated time of the interaction up to the current time point, and the like. The closeness level is calculated to become higher as the number of times an interaction is made up to the current time point becomes larger. In addition, the closeness level is calculated to become higher as the accumulated time of the interaction up to the current time point becomes longer. The closeness level may be calculated on the basis of both the number of times of the interaction and the accumulated time, or may be calculated using only one of the parameters. It is noted that the accumulated time can also be expressed as a total time or an accumulative total time.

For example, the closeness level can be set in five levels under the conditions as follows.
Closeness level 1: Met for the first time (a partner that has become an interaction target for the first time) (newly-met object)
Closeness level 2: Acquaintance (an interaction has been made two times or more, and the number of interactions of 1 hour or more is less than three times) (acquaintance object)
Closeness level 3: Friend (the number of interactions of 1 hour or more is three times or more and less than 10 times) (friend object)
Closeness level 4: Best friend (the number of interactions of 1 hour or more is 10 times or more and less than 50 times) (best-friend object)
Closeness level 5: Closest friend (the number of interactions of 1 hour or more is 50 times or more) (closest-friend object)

The closeness level setting method is not limited, and an arbitrary method may be adopted. For example, the closeness level may be calculated using parameters other than the number of times of the interaction and the accumulated time of the interaction. For example, various types of information that indicate a hometown, age, hobby, presence or absence of a blood relationship, and whether or not one is a graduate of the same school may be used. For example, these pieces of information can be set by the scene description information. Accordingly, the user acquaintance list information update unit 25 may calculate the closeness level on the basis of the scene description information and update the user acquaintance list.

Further, the method of classifying the closeness levels (level classification) is also not limited. Without being limited to the case of classifying the closeness level into five levels as described above, an arbitrary setting method that uses two levels, three levels, 10 levels, or the like may be adopted instead.

The user acquaintance list is used for the processing resource distribution of each object. In other words, in the present embodiment, the processing resource distribution unit 20 sets the processing resources with respect to the another user object 7 on the basis of the closeness level (friendship level) calculated by the user acquaintance list information update unit 25.

The update of the user acquaintance list may be executed in link with the starting predictive behavior determination, or may be executed in link with the ending predictive behavior determination. Of course, the user acquaintance list may be updated in link with both of the starting predictive behavior determination and the ending predictive behavior determination.

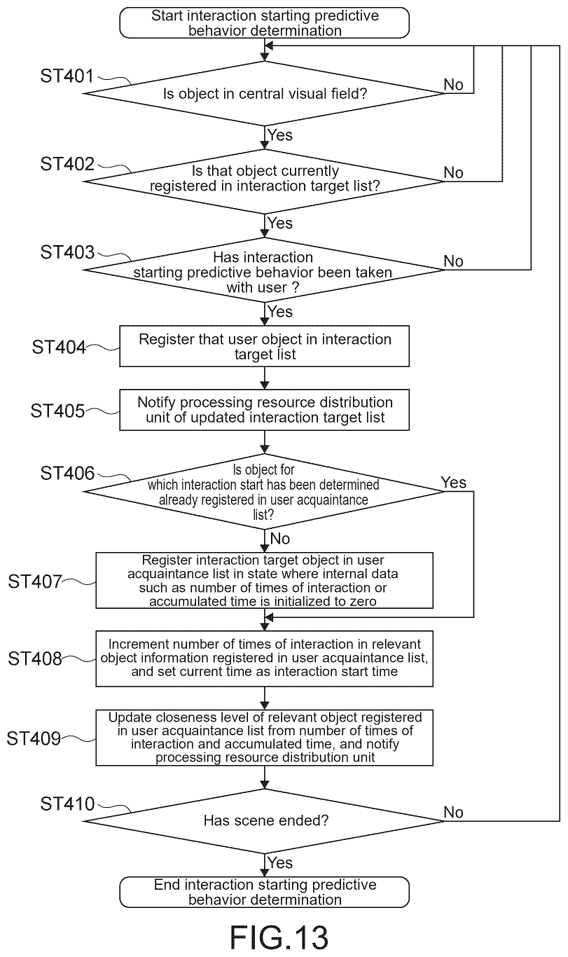

FIG. 13 is a flowchart showing an update example of the user acquaintance list linked to the starting predictive behavior determination.

Steps 401 to 405 shown in FIG. 13 are similar to Steps 201 to 205 shown in FIG. 8 and are executed by the interaction target information update unit 19.

Steps 406 to 409 are executed by the user acquaintance list information update unit 25.

In Step 406, it is determined whether or not the interaction target object for which the interaction start has been determined is already registered in the user acquaintance list. When the object is not registered in the user acquaintance list (No in Step 406), the interaction target object is registered in the user acquaintance list in a state where internal data such as the number of times of the interaction or the accumulated time is initialized to zero.

When it is determined in Step 406 that the interaction target object is already registered in the user acquaintance list (determination result Yes), the processing skips to Step 408.

In Step 408, the number of times of the interaction in the information of the object registered in the user acquaintance list is incremented. In addition, the current time corresponding to the current time point is set as the interaction start time.

In Step 409, the closeness level of the object registered in the user acquaintance list is calculated from the number of times of the interaction and the accumulated time and is updated. The updated user acquaintance list is notified to the processing resource distribution unit 20.

The update of the interaction target list and the update of the user acquaintance list are repeated until the scene ends (Step 410).

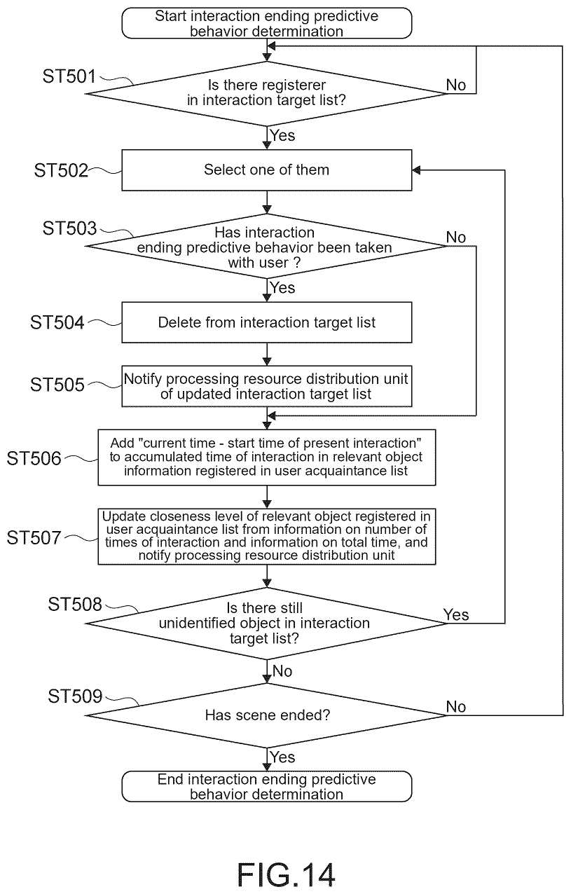

FIG. 14 is a flowchart showing an update example of the user acquaintance list linked to the ending predictive behavior determination.

Steps 501 to 505 shown in FIG. 14 are similar to Steps 301 to 305 shown in FIG. 9 and are executed by the interaction target information update unit 19.

Steps 506 and 507 are executed by the user acquaintance list information update unit 25.

In Step 506, a time obtained by subtracting the interaction start time from the current time is added to the accumulated time of the interaction in the information of the object registered in the user acquaintance list as a time for which the present interaction has been performed.

In Step 507, the closeness level of the object registered in the user acquaintance list is calculated from the number of times of the interaction and the accumulated time and is updated. The updated user acquaintance list is notified to the processing resource distribution unit 20 (Step 507).

The interaction ending predictive behavior determination and the update of the user acquaintance list are executed for all of the objects registered in the interaction target list (Step 508). The update of the interaction target list and the update of the user acquaintance list are repeated until the scene ends (Step 509).

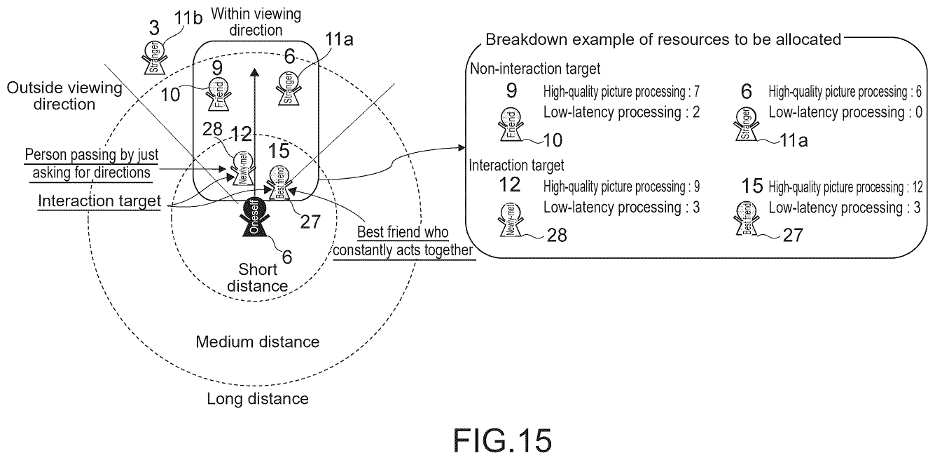

FIG. 15 is a schematic diagram for explaining an example of the processing resource distribution that uses the closeness level according to the present embodiment.

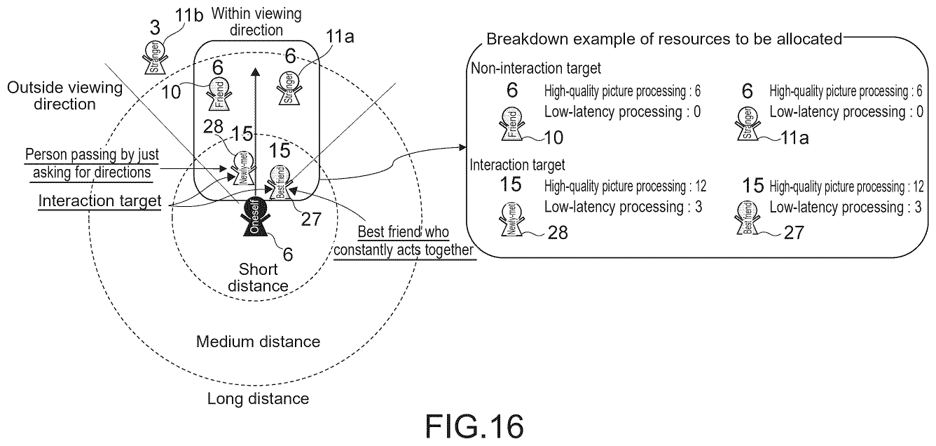

FIG. 16 is a schematic diagram showing an example of the processing resource distribution in a case where the closeness level is not used.

The examples shown in FIGS. 15 and 16 each show a scene where the user object 6 of oneself, a best-friend object 27 (closeness level 4), the friend object 10 (closeness level 3), a newly-met object 28 (closeness level 1), and the stranger objects 11a and 11b are displayed. It is noted that the stranger objects 11a and 11b are objects that have never become interaction target objects up to now and whose closeness levels are not calculated.

Also in the examples shown in FIGS. 15 and 16, at the current time point, the best-friend object 27 and the newly-met object 28 are the interaction target objects. Other objects are the non-interaction target objects.

The scene shown in FIGS. 15 and 16 is a scene where, while one is with a best friend who constantly acts together, a newly-met person passing by says something to ask for directions, and a friend is present behind that person. The best friend is the best-friend object 27 that is the interaction target object. The newly-met person asking for directions is the newly-met object 28 that becomes the interaction target object. The fried behind is the friend object 10 that is the non-interaction target object not yet performing an interaction.

As exemplified in FIG. 16, when the closeness level is not used, the same “15” is allocated as the resource distribution score on the basis of the determination that the best-friend object 27 that constantly acts together and the newly-met object 28 that is passing by and only asking for directions are both the interaction target objects.

Since the newly-met object 28 passing by is also the interaction target, if a delay occurs in the communication, realism is impaired. Accordingly, the same score as the best-friend object 27 needs to be allocated for the resources with respect to the low-latency processing, but there is no need to pursue visual reality to that extent.

Meanwhile, behind the newly-met object 28, the friend object 10 that is currently the non-interaction target object and the stranger object 11a that is also the non-interaction target object are present at positions at almost the same distance. Also, to these friend object 10 and stranger object 11a, the same score “6” is allocated.

Herein, since an attention level (importance degree) of the friend object 10 from the user 2 is apparently higher and the friend object 10 is within eyesight of the user 2, an interaction using a gesture of waving a hand or the like upon noticing could start any minute. If the resource distribution to the low-latency processing is performed to some extent in preparation of such a sudden start of the interaction, the interaction can be started more smoothly.

Therefore, although the friend object 10 is currently the non-interaction target object, it is more desirable to allocate many processing resources to this friend object 10 in the viewpoint of each of the high-quality picture processing and the low-latency processing so as not to impair the realism that the user feels.

In the present embodiment, the processing resource distribution can be executed using the closeness level managed by the user acquaintance list. Accordingly, as exemplified in FIG. 15, the processing resources allocated to the high-quality picture processing with respect to the newly-met object 28 passing by, that has a low importance degree for the user 2, is reduced by “3”. Then, that reduced amount of processing resources are allocated to the friend object 10 that is the non-interaction target object but has a high closeness level and is highly likely to perform an interaction thereafter.

In this manner, by calculating and updating the closeness level from the interaction status up to now and using that closeness level, a more optimal resource distribution on which even a difference in importance degree for the user between the interaction partners or the non-interaction partners is reflected becomes possible.

It is noted that by converting information of the user acquaintance list generated for each user 2 into a file and disclosing it on the network 8 as data of each user 2, the data can be reused in various spaces of the metaverse. As a result, it becomes possible to realize high-quality virtual video broadcasting and the like.

### Third Embodiment

As the processing for pursuing realism in each scene in the virtual space S, there are the high-quality picture processing for pursuing visual realism, the low-latency processing for pursuing responsive realism, and the like. In the first and second embodiments, the processing resources allocated to each object are further distributed to either the high-quality picture processing or the low-latency processing.

In the bidirectional remote communication like metaverse, various use cases and scenes are conceivable, and a type of reality (quality) that is required for each of the scenes differs.

For example, in a scene of a music concert in which a musician plays and sings on stage, visual reality becomes important in many cases. For example, it is considered that during the concert, interactions with others are hardly made and realistic sensations for immersing in the concert space are required in many cases. In such a scene, it is considered that the realism can be pursued by prioritizing the high-quality picture processing.

Further, in a scene of a remote work or the like that requires a precise cooperative activity, it is considered that responsive realism becomes important in many cases. For example, if a deviation is caused in motions among collaborators due to a delay or the like, the precise cooperative activity is considered to become difficult. In such a scene, it is considered that the realism can be pursued by prioritizing the low-latency processing.

Of course, the low-latency processing may become important in a music concert or the like that involves dances and the like. In addition, in a case where a delicate motion of a fingertip or the like of the collaborator needs to be grasped, or the like, the high-quality picture processing may become important. In either case, it is often the case that the reality to be prioritized is determined for each of the scenes.

On the basis of such a viewpoint, the inventors have newly devised to control which processing for improving what reality the processing resources allocated to each object are to be preferentially distributed to, to thus improve the realism of each of the scenes.

Specifically, the reality that the current scene emphasizes is described in a scene description (Scene Description) file used as the scene description information. Thus, it becomes possible to explicitly tell the client apparatus 5 which processing the processing resources that have been allocated to each object are to be preferentially distributed to. In other words, it becomes possible to control, in each of the scenes, which processing the processing resources that have been allocated to each object are to be preferentially distributed to, and perform more optimal resource distribution that matches the current scene.

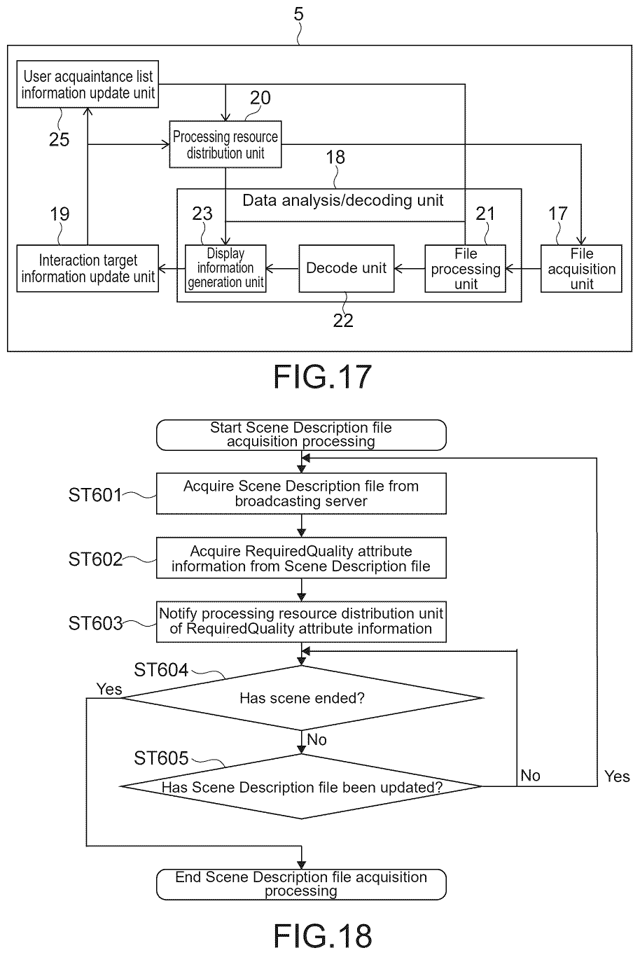

FIG. 17 is a schematic diagram showing a configuration example of the client apparatus 5 according to the third embodiment.

FIG. 18 is a flowchart showing an example of processing of acquiring a scene description file that is used as the scene description information.

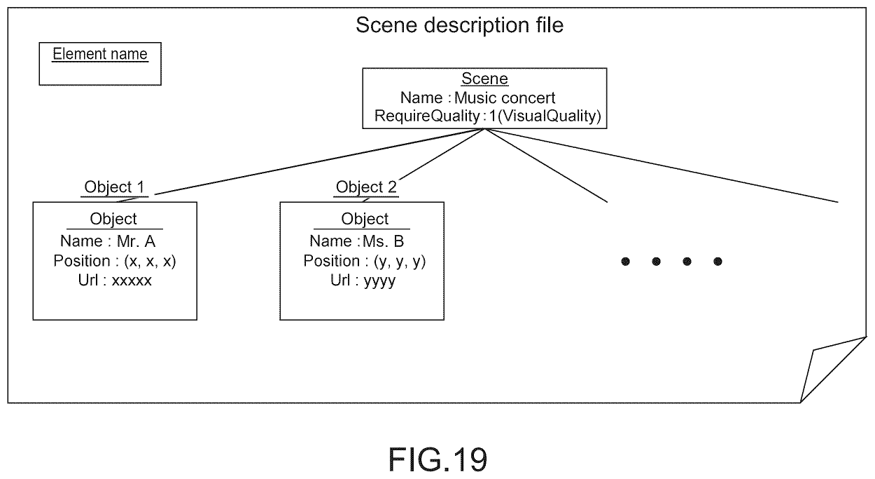

FIGS. 19 to 22 are each a schematic diagram showing an example of information described in the scene description file.

In the following examples, cases where the high-quality picture processing and the low-latency processing are executed as the processing for improving reality are exemplified.

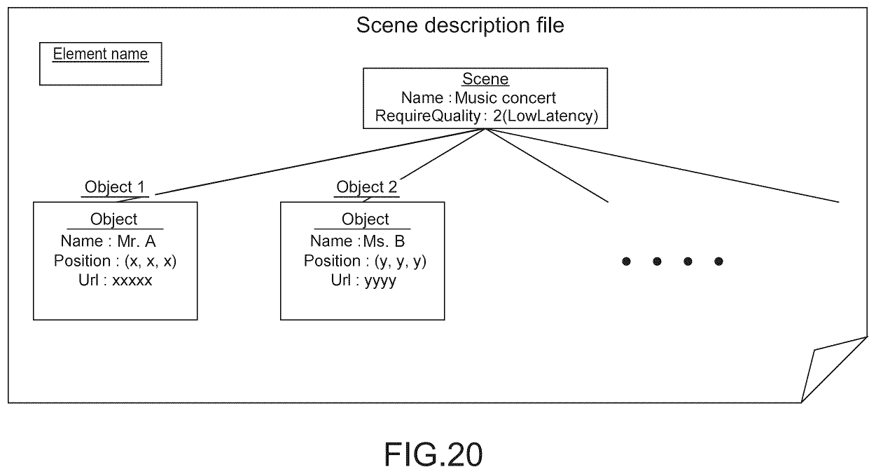

In the examples shown in FIGS. 19 and 20, the following information is stored as scene information described in the scene description file.
Name . . . name of scene
RequireQuality . . . reality (quality) to be prioritized (1=VisualQuallity/2=LowLatency)

In this manner, in the present embodiment, a field for describing “RequireQuality” is newly defined as one of scene element attributes in the scene description file. “RequireQuality” can also be referred to as information that indicates which reality (quality) the user 2 wishes to be guaranteed when experiencing the scene.

In the example shown in FIG. 19, “VisualQuallity” that is information indicating that visual quality is required is described. From this information, the client apparatus 5 executes, regarding the processing resources allocated to each object, the resource distribution while prioritizing the high-quality picture processing.

In the example shown in FIG. 20, “LowLatency” that is information indicating that responsive quality is required is described. From this information, the client apparatus 5 executes, regarding the processing resources allocated to each object, the resource distribution while prioritizing the low-latency processing.

For example, regarding the scene shown in FIG. 15, a distribution score “15” is allocated to the best-friend object 27. For example, when “VisualQuallity” is described in the scene description file, the score is preferentially distributed to the high-quality picture processing out of the score “15”. Conversely, when “LowLatency” is described in the scene description file, the score is preferentially distributed to the low-latency processing out of the score “15”. The specific score distribution may be set as appropriate according to the contents of implementation.

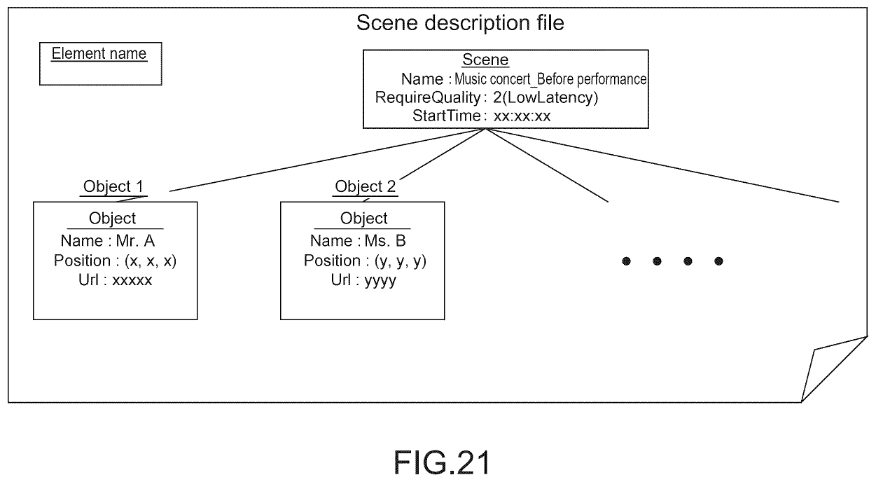

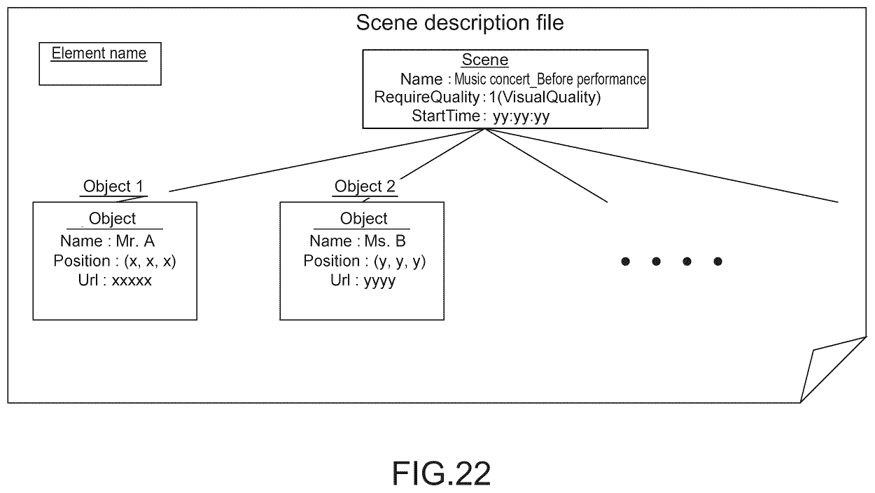

In the examples shown in FIGS. 21 and 22, “StartTime” is further described as the scene information described in the scene description file. “StartTime” is information indicating a start time of the scene.

For example, a scene showing a state before performance of a music concert is started from the time of “StartTime” described in the scene description file shown in FIG. 21. Then, upon reaching the time of “StartTime” described in the scene description file shown in FIG. 22, the scene is updated to a scene that shows a state during performance of the music concert, that is, the performance is started.

As shown in FIG. 21, in the scene that shows the state before the performance, “RequireQuality” becomes “LowLatency”, and thus the low-latency processing is prioritized. On the other hand, as shown in FIG. 22, in the scene that shows the state during the performance, “RequireQuality” becomes “VisualQuallity”, and thus the high-quality picture processing is prioritized.

As exemplified in FIGS. 21 and 22, by executing the scene update, a change over time in reality (quality) required for each scene can be described dynamically.

For example, the changes in required reality (quality) in the music concert as follows can be described dynamically.
Before concert starts: “RequireQuality”=“LowLatency” (low-latency processing is prioritized)
During performance: “RequireQuality”=“VisualQuallity” (high-quality picture processing is prioritized)
During MC: “RequireQuality”=“LowLatency” (low-latency processing is prioritized)
During performance: “RequireQuality”=“VisualQuallity” (high-quality picture processing is prioritized)
End of concert: “RequireQuality”=“LowLatency” (low-latency processing is prioritized)

As shown in FIG. 18, in the present embodiment, the file acquisition unit 17 acquires the scene description file from the broadcasting server 3 (Step 601).

The file processing unit 21 acquires attribute information of “RequireQuality” from the scene description file (Step 602).

The file processing unit 21 notifies the processing resource distribution unit 20 of the attribute information of “RequireQuality” (Step 603).

It is determined whether or not the scene description file has been updated before the scene is ended, that is, whether or not the scene update as exemplified in FIGS. 21 and 22 has been executed (Steps 604 and 605).

When the scene update has been executed (YES in Step 605), the processing returns to Step 601. When the scene update has not been executed (NO in Step 605), the processing returns to Step 604. When the scene is ended (Yes in Step 604), the scene description file acquisition processing is ended.

In this manner, in the present embodiment, the file acquisition unit 17 and the file processing unit 21 realize a priority processing determination unit so as to determine the processing to which the processing resources are to be preferentially allocated with respect to a scene constituted of the three-dimensional space (virtual space S). The priority processing determination unit (file acquisition unit 17 and file processing unit 21) determines the processing to which the processing resources are to be preferentially allocated on the basis of three-dimensional space description data (scene description information) that defines the configuration of the three-dimensional space.

The processing resource distribution unit 20 that functions as the resource setting unit sets the processing resources with respect to the other user objects 7 on the basis of the determination result obtained by the priority processing determination unit (file acquisition unit 17 and file processing unit 21).

In the first and second embodiments described above, it has been possible to appropriately determine the object to become a target for preferentially allocating the processing resources. In the third embodiment, it becomes possible to appropriately determine the processing to become a target for preferentially allocating the processing resources (processing for pursuing true realism).

### Other Embodiments

The present technology is not limited to the embodiments described above, and various other embodiments can be realized.

### [Client-Side Rendering/Server-Side Rendering]

As described above, in the example shown in FIG. 1, the client apparatus 5 executes the rendering processing so as to generate two-dimensional video data (rendering video) corresponding to the eyesight of the user 2. In other words, in the example shown in FIG. 1, a configuration of a client-side rendering system is adopted as the 6DoF video broadcasting system.

The 6DoF video broadcasting system to which the present technology can be applied is not limited to the client-side rendering system and is also applicable to other broadcasting systems such as a server-side rendering system.

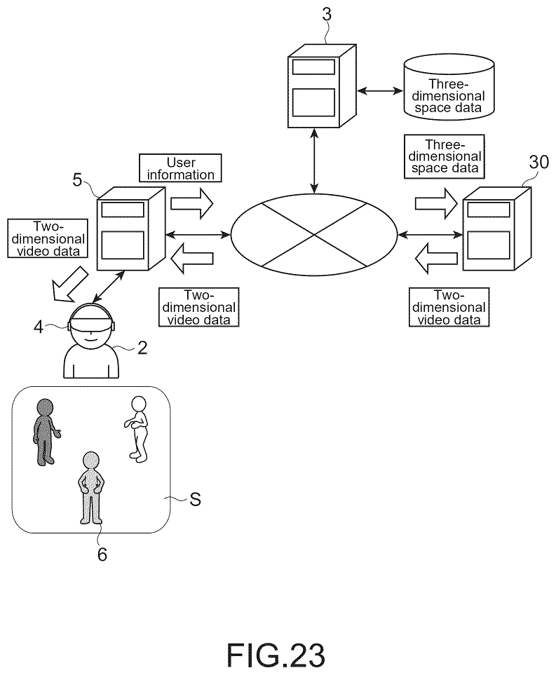

FIG. 23 is a schematic diagram for explaining a configuration example of the server-side rendering system.

In the server-side rendering system, a rendering server 30 is constructed on the network 8. The rendering server 30 is communicably connected to the broadcasting server 3 and the client apparatus 5 via the network 8. For example, the rendering server 30 can be realized by an arbitrary computer such as a PC.

As exemplified in FIG. 23, user information is transmitted from the client apparatus 5 to the broadcasting server 3 and the rendering server 30. The broadcasting server 3 generates three-dimensional space data such that motions, utterances, and the like of the user 2 are reflected, and broadcasts it to the rendering server 30. The rendering server 30 executes the rendering processing shown in FIG. 2 on the basis of the eyesight information of the user 2. Thus, two-dimensional video data (rendering video) corresponding to the eyesight of the user 2 is generated. In addition, voice information and output control information are generated.

The rendering video, voice information, and output control information generated by the rendering server 30 are encoded (encoding) and transmitted to the client apparatus 5. The client apparatus 5 decodes the received rendering video and the like and transmits them to the HMD 4 worn by the user 2. The HMD 4 displays the rendering video and also outputs the voice information.

By adopting the configuration of the server-side rendering system, a processing load on the client apparatus 5 side can be unloaded to the rendering server 30 side so that even when the client apparatus 5 having low processing performance is used, the user 2 can still experience the 6DoF video.

In such a server-side rendering system, the processing resource setting that uses the starting predictive behavior determination and the ending predictive behavior determination according to the present technology can be applied. For example, the functional configuration of the client apparatus 5 that has been described with reference to FIGS. 7, 12, and 17 is applied to the rendering server 30.

Thus, as described in the respective embodiments above, it becomes possible to appropriately determine the interaction target and allocate many processing resources in the remote communication space like the metaverse. In other words, it becomes possible to realize an optimal resource distribution in which the processing resources are suppressed without impairing the realism that the user 2 feels. As a result, it becomes possible to realize high-quality virtual videos.

When constructing the server-side rendering system, the rendering server 30 functions as an embodiment of the information processing apparatus according to the present technology. Then, the rendering server 30 executes an embodiment of the information processing method according to the present technology.

It is noted that the rendering server 30 may be prepared for each user 2, or may be prepared for a plurality of users 2. Further, the configuration of the client-side rendering and the configuration of the server-side rendering may be configured individually for each of the users 2. In other words, the configuration of the client-side rendering and the configuration of the server-side rendering may both be adopted for realizing the remote communication system 1.

In the descriptions above, the high-quality picture processing and the low-latency processing have been exemplified as the processing for pursuing realism in each scene in the virtual space S (processing for improving reality). Without being limited to these processing, arbitrary processing for reproducing various types of realism that human beings feel in the real world is included as the processing to which the processing resource distribution according to the present technology can be applied. For example, when a device or the like capable of reproducing stimulations to the five senses including a visual sense, an auditory sense, a tactile sense, an olfactory sense, a taste sense, and the like is used, the realism of each scene in the virtual space S can be pursued by executing processing for realistically reproducing the stimulations. By applying the present technology, it becomes possible to perform an optimal resource distribution with respect to these processing.

In the descriptions above, the case where the avatar of the user 2 him/herself is displayed as the user object 6 has been taken as an example. Then, the presence or absence of the interaction starting predictive behavior and the presence or absence of the interaction ending predictive behavior have been determined between the user object 6 and the other user objects 7. Without being limited to this, the present technology is also applicable to a form in which the avatar of the user 2 him/herself, that is, the user object 6 is not displayed.

For example, as in the real world, it is also possible to execute an interaction with the other user objects 7 such as friends and strangers while the eyesight of oneself is expressed as it is in the virtual space S. Also in such a case, it is possible to determine the presence or absence of the interaction starting predictive behavior and the presence or absence of the interaction ending predictive behavior with the other objects on the basis of the user information of oneself and the other user information of the other users. In other words, by applying the present technology, an optimal resource distribution becomes possible. It is noted that similar to the real world, avatars of hands and legs, and the like may be displayed when hands, legs, and the like of oneself enter the eyesight. In this case, the avatars of the hands, legs, and the like can also be referred to as user objects 6.

In the descriptions above, the case where a 6DoF video including 360-degree space video data is broadcasted as the virtual image has been taken as an example. Without being limited to this, the present technology is also applicable to a case where a 3DoF video, a 2D video, and the like are broadcasted. Further, an AR video or the like may be broadcasted as the virtual image instead of the VR video. Furthermore, the present technology is also applicable to stereo videos (e.g., right-eye image, left-eye image, and the like) for viewing 3D videos.

FIG. 24 is a block diagram showing a hardware configuration example of a computer (information processing apparatus) 60 that is capable of realizing the broadcasting server 3, the client apparatus 5, and the rendering server 30.

The computer 60 includes a CPU 61, a ROM 62, a RAM 63, an input/output interface 65, and a bus 64 that mutually connect these. Connected to the input/output interface 65 are a display unit 66, an input unit 67, a storage unit 68, a communication unit 69, a drive unit 70, and the like.

The display unit 66 is, for example, a display device that uses liquid crystal, EL, or the like. The input unit 67 is, for example, a keyboard, a pointing device, a touch panel, or other operation apparatuses. When the input unit 67 includes a touch panel, that touch panel may be integrated with the display unit 66.

The storage unit 68 is a nonvolatile storage device and is, for example, an HDD, a flash memory, or other solid-state memories. The drive unit 70 is, for example, a device capable of driving a removable recording medium 71 such as an optical recording medium and a magnetic recording tape.

The communication unit 69 is a modem, a router, or other communication apparatuses that is/are connectable to a LAN, a WAN, and the like and used for communicating with other devices. The communication unit 69 may communicate in either a wired manner or wirelessly. The communication unit 69 is often used separately from the computer 60.

Information processing by the computer 60 having the hardware configuration as described above is realized by cooperation of software stored in the storage unit 68, the ROM 62, and the like and hardware resources of the computer 60. Specifically, a program configuring software, that is stored in the ROM 62 or the like, is loaded to the RAM 63 and executed so as to realize the information processing method according to the present technology.

The program is installed in the computer 60 via the recording medium 61, for example. Alternatively, the program may be installed in the computer 60 via a global network or the like. Alternatively, an arbitrary non-transitory computer-readable storage medium may be used.

A plurality of computers communicably connected via the network or the like may cooperate with one another to thus execute the information processing method according to the present technology and the program and construct the information processing apparatus according to the present technology.

In other words, the information processing method according to the present technology and the program can be executed in not only the computer system constituted of a single computer but also a computer system in which the plurality of computers operate in an interlocking manner.

It is noted that in the present disclosure, the system refers to an aggregation of a plurality of constituent elements (apparatuses, modules (components), and the like), and whether or not all of the constituent elements are within the same housing is irrelevant. Accordingly, a plurality of apparatuses that are housed in separate housings and are connected via a network and a single apparatus in which a plurality of modules are housed in a single housing are both systems.

The execution of the information processing method according to the present technology and the program by the computer system includes, for example, both of a case where the determination on the presence or absence of the starting predictive behavior, the determination on the presence or absence of the ending predictive behavior, the processing resource setting, the execution of the rendering processing, the acquisition of the user information (other user information), the calculation of the friendship level, the determination on the priority processing, and the like are executed by a single computer and a case where the respective processing is executed by different computers. Moreover, the execution of the respective processing by a predetermined computer includes causing other computers to execute a part or all of the processing and acquiring results thereof.

In other words, the information processing method according to the present technology and the program can also be applied to a configuration of cloud computing in which a plurality of apparatuses share and cooperate to process a single function via a network.

The respective configurations, processing flows, and the like of the remote communication system, the client-side rendering system, the server-side rendering system, the broadcasting server, the client apparatus, the rendering server, the HMD, and the like that have been described with reference to the respective figures are mere embodiments and can be arbitrarily modified without departing from the gist of the present technology. In other words, other arbitrary configurations, algorithms, and the like for embodying the present technology may be adopted.

In the present disclosure, to help understand the descriptions, the terms “substantially”, “approximately”, “roughly”, and the like are used as appropriate. Meanwhile, no clear difference is defined between a case where these terms “substantially”, “approximately”, “roughly”, and the like are used and a case where the terms are not used.

In other words, in the present disclosure, a concept defining a shape, a size, a positional relationship, a state, and the like such as “center”, “middle”, “uniform”, “equal”, “same”, “orthogonal”, “parallel”, “symmetric”, “extend”, “axial direction”, “circular cylinder shape”, “cylindrical shape”, “ring shape”, and “circular ring shape” is a concept including “substantially at the center”, “substantially in the middle”, “substantially uniform”, “substantially equal”, “substantially the same”, “substantially orthogonal”, “substantially parallel”, “substantially symmetric”, “extend substantially”, “substantially the axial direction”, “substantially the circular cylinder shape”, “substantially the cylindrical shape”, “substantially the ring shape”, “substantially the circular ring shape”, and the like.

For example, a state within a predetermined range (e.g., range within ±10%) that uses “completely at the center”, “completely in the middle”, “completely uniform”, “completely equal”, “completely the same”, “completely orthogonal”, “completely parallel”, “completely symmetric”, “extend completely”, “completely the axial direction”, “completely the circular cylinder shape”, “completely the cylindrical shape”, “completely the ring shape”, “completely the circular ring shape”, and the like as a reference is also included.

Accordingly, even when the terms “substantially”, “approximately”, “roughly”, and the like are not added, what you might call a concept that may be expressed by adding “substantially”, “approximately”, “roughly”, and the like may be included. Conversely, a complete state is not necessarily excluded regarding the state expressed by adding “substantially”, “approximately”, “roughly”, and the like.

In the present disclosure, expressions that use “than” as in “larger than A” and “smaller than A” are expressions that comprehensively include both of a concept including a case of being equal to A and a concept not including the case of being equal to A. For example, “larger than A” is not limited to a case that does not include equal to A and also includes “A or more”. In addition, “smaller than A” is not limited to “less than A” and also includes “A or less”.

In embodying the present technology, specific settings and the like only need to be adopted as appropriate from the concepts included in “larger than A” and “smaller than A” so that the effects described above are exerted.

Of the feature portions according to the present technology described above, at least two of the feature portions can be combined. In other words, the various feature portions described in the respective embodiments may be arbitrarily combined without distinction of the embodiments. Moreover, the various effects described above are mere examples and are not limited, and other effects may also be exerted.

It is noted that the present technology can also take the following configurations.

(1) An information processing apparatus, including:
a starting predictive behavior determination unit which determines, with respect to another user object that is a virtual object corresponding to another user within a three-dimensional space, presence or absence of a starting predictive behavior that becomes a sign to start an interaction with a user;
an ending predictive behavior determination unit which determines, with respect to an interaction target object that is the another user object that has been determined as having taken the starting predictive behavior, presence or absence of an ending predictive behavior that becomes a sign to end the interaction; and
a resource setting unit which sets, with respect to the interaction target object, processing resources that are used in processing for improving reality to be relatively high until it is determined that the ending predictive behavior has been taken.

(2) The information processing apparatus according to (1), in which
the starting predictive behavior includes a behavior that becomes a sign to start an interaction between a user object that is a virtual object corresponding to the user and the another user object, and
the ending predictive behavior includes a behavior that becomes a sign to end the interaction between the user object and the another user object.

(3) The information processing apparatus according to (2), in which
the starting predictive behavior includes at least one of the user object performing an interaction-related behavior related to the interaction with resect to the another user object, the another user object performing the interaction-related behavior with respect to the user object, the another user object responding to, by the interaction-related behavior, the interaction-related behavior that has been performed by the user object with respect to the another user object, the user object responding to, by the interaction-related behavior, the interaction-related behavior that has been performed by the another user object with respect to the user object, or the user object and the another user object mutually performing the interaction-related behavior.

(4) The information processing apparatus according to (3), in which
the interaction-related behavior includes at least one of speaking while looking at a partner, performing a predetermined gesture while looking at the partner, touching the partner, or touching a same virtual object that the partner is touching.

(5) The information processing apparatus according to any one of (2) to (4), in which
the ending predictive behavior includes at least one of moving away while being mutually out of eyesight of a partner, an elapse of a certain time while being mutually out of the eyesight of the partner and taking no action with respect to the partner, or an elapse of a certain time while being mutually out of a central visual field of the partner and taking no visual action with respect to the partner.

(6) The information processing apparatus according to any one of (1) to (5), in which
the starting predictive behavior determination unit determines the presence or absence of the starting predictive behavior on a basis of user information related to the user and another user information related to the another user, and
the ending predictive behavior determination unit determines the presence or absence of the ending predictive behavior on the basis of the user information and the another user information.

(7) The information processing apparatus according to (6), in which
the user information includes at least one of eyesight information of the user, motion information of the user, voice information of the user, or contact information of the user, and
the another user information includes at least one of eyesight information of the another user, motion information of the another user, voice information of the another user, or contact information of the another user.

(8) The information processing apparatus according to any one of (1) to (7), in which
the processing resources that are used in the processing for improving reality include processing resources used in at least one of high-quality picture processing for improving visual reality or low-latency processing for improving responsive reality in the interaction.

(9) The information processing apparatus according to any one of (2) to (8), further including:
a friendship level calculation unit which calculates a friendship level of the another user object with respect to the user object,
in which the resource setting unit sets the processing resources with respect to the another user object on a basis of the calculated friendship level.

(10) The information processing apparatus according to (9), in which
the friendship level calculation unit calculates the friendship level on a basis of at least one of a number of times the interaction has been made up to a current time point or an accumulated time of the interaction up to the current time point.

(11) The information processing apparatus according to any one of (1) to (10), further including:
a priority processing determination unit which determines processing to which the processing resources are to be preferentially allocated with respect to a scene constituted of the three-dimensional space,
in which the resource setting unit sets the processing resources with respect to the another user object on a basis of a result of the determination by the priority processing determination unit.

(12) The information processing apparatus according to (11), in which
the priority processing determination unit selects either one of high-quality picture processing or low-latency processing as the processing to which the processing resources are to be preferentially allocated.

(13) The information processing apparatus according to (11) or (12), in which
the priority processing determination unit determines the processing to which the processing resources are to be preferentially allocated on a basis of three-dimensional space description data that defines a configuration of the three-dimensional space.

(14) An information processing method executed by a computer system, including:
determining, with respect to another user object that is a virtual object corresponding to another user within a three-dimensional space, presence or absence of a starting predictive behavior that becomes a sign to start an interaction with a user;
determining, with respect to an interaction target object that is the another user object that has been determined as having taken the starting predictive behavior, presence or absence of an ending predictive behavior that becomes a sign to end the interaction; and
setting, with respect to the interaction target object, processing resources that are used in processing for improving reality to be relatively high until it is determined that the ending predictive behavior has been taken.

(15) An information processing system, including:
a starting predictive behavior determination unit which determines, with respect to another user object that is a virtual object corresponding to another user within a three-dimensional space, presence or absence of a starting predictive behavior that becomes a sign to start an interaction with a user;
an ending predictive behavior determination unit which determines, with respect to an interaction target object that is the another user object that has been determined as having taken the starting predictive behavior, presence or absence of an ending predictive behavior that becomes a sign to end the interaction; and
a resource setting unit which sets, with respect to the interaction target object, processing resources that are used in processing for improving reality to be relatively high until it is determined that the ending predictive behavior has been taken.

### REFERENCE SIGNS LIST

S virtual space
1 remote communication system
2 user
3 broadcasting server
4 HMD
5 client apparatus
6 user object
7 another user object
10 friend object
11 stranger object
13 starting predictive behavior determination unit
14 ending predictive behavior determination unit
15 resource setting unit
27 best-friend object
28 newly-met object
30 rendering server
60 computer

1. An information processing apparatus, comprising:
a starting predictive behavior determination unit which determines, with respect to another user object that is a virtual object corresponding to another user within a three-dimensional space, presence or absence of a starting predictive behavior that becomes a sign to start an interaction with a user;
an ending predictive behavior determination unit which determines, with respect to an interaction target object that is the another user object that has been determined as having taken the starting predictive behavior, presence or absence of an ending predictive behavior that becomes a sign to end the interaction; and
a resource setting unit which sets, with respect to the interaction target object, processing resources that are used in processing for improving reality to be relatively high until it is determined that the ending predictive behavior has been taken.

2. The information processing apparatus according to claim 1, wherein
the starting predictive behavior includes a behavior that becomes a sign to start an interaction between a user object that is a virtual object corresponding to the user and the another user object, and
the ending predictive behavior includes a behavior that becomes a sign to end the interaction between the user object and the another user object.

3. The information processing apparatus according to claim 2, wherein
the starting predictive behavior includes at least one of the user object performing an interaction-related behavior related to the interaction with resect to the another user object, the another user object performing the interaction-related behavior with respect to the user object, the another user object responding to, by the interaction-related behavior, the interaction-related behavior that has been performed by the user object with respect to the another user object, the user object responding to, by the interaction-related behavior, the interaction-related behavior that has been performed by the another user object with respect to the user object, or the user object and the another user object mutually performing the interaction-related behavior.

4. The information processing apparatus according to claim 3, wherein
the interaction-related behavior includes at least one of speaking while looking at a partner, performing a predetermined gesture while looking at the partner, touching the partner, or touching a same virtual object that the partner is touching.

5. The information processing apparatus according to claim 2, wherein
the ending predictive behavior includes at least one of moving away while being mutually out of eyesight of a partner, an elapse of a certain time while being mutually out of the eyesight of the partner and taking no action with respect to the partner, or an elapse of a certain time while being mutually out of a central visual field of the partner and taking no visual action with respect to the partner.

6. The information processing apparatus according to claim 1, wherein
the starting predictive behavior determination unit determines the presence or absence of the starting predictive behavior on a basis of user information related to the user and another user information related to the another user, and
the ending predictive behavior determination unit determines the presence or absence of the ending predictive behavior on the basis of the user information and the another user information.

7. The information processing apparatus according to claim 6, wherein
the user information includes at least one of eyesight information of the user, motion information of the user, voice information of the user, or contact information of the user, and
the another user information includes at least one of eyesight information of the another user, motion information of the another user, voice information of the another user, or contact information of the another user.

8. The information processing apparatus according to claim 1, wherein
the processing resources that are used in the processing for improving reality include processing resources used in at least one of high-quality picture processing for improving visual reality or low-latency processing for improving responsive reality in the interaction.

9. The information processing apparatus according to claim 2, further comprising:
a friendship level calculation unit which calculates a friendship level of the another user object with respect to the user object,
wherein the resource setting unit sets the processing resources with respect to the another user object on a basis of the calculated friendship level.

10. The information processing apparatus according to claim 9, wherein
the friendship level calculation unit calculates the friendship level on a basis of at least one of a number of times the interaction has been made up to a current time point or an accumulated time of the interaction up to the current time point.

11. The information processing apparatus according to claim 1, further comprising:
a priority processing determination unit which determines processing to which the processing resources are to be preferentially allocated with respect to a scene constituted of the three-dimensional space,
wherein the resource setting unit sets the processing resources with respect to the another user object on a basis of a result of the determination by the priority processing determination unit.

12. The information processing apparatus according to claim 11, wherein
the priority processing determination unit selects either one of high-quality picture processing or low-latency processing as the processing to which the processing resources are to be preferentially allocated.

13. The information processing apparatus according to claim 11, wherein
the priority processing determination unit determines the processing to which the processing resources are to be preferentially allocated on a basis of three-dimensional space description data that defines a configuration of the three-dimensional space.

14. An information processing method executed by a computer system, comprising:
determining, with respect to another user object that is a virtual object corresponding to another user within a three-dimensional space, presence or absence of a starting predictive behavior that becomes a sign to start an interaction with a user;
determining, with respect to an interaction target object that is the another user object that has been determined as having taken the starting predictive behavior, presence or absence of an ending predictive behavior that becomes a sign to end the interaction; and
setting, with respect to the interaction target object, processing resources that are used in processing for improving reality to be relatively high until it is determined that the ending predictive behavior has been taken.

15. An information processing system, comprising:
a starting predictive behavior determination unit which determines, with respect to another user object that is a virtual object corresponding to another user within a three-dimensional space, presence or absence of a starting predictive behavior that becomes a sign to start an interaction with a user;
an ending predictive behavior determination unit which determines, with respect to an interaction target object that is the another user object that has been determined as having taken the starting predictive behavior, presence or absence of an ending predictive behavior that becomes a sign to end the interaction; and
a resource setting unit which sets, with respect to the interaction target object, processing resources that are used in processing for improving reality to be relatively high until it is determined that the ending predictive behavior has been taken.
